(19) United States
(12) Patent Application Publication
(10) Pub. No.: US 2026/0103569 A1
(43) Pub. Date: Apr. 16, 2026

(54) DYNAMIC ABLATIVE NETWORKS, METHODS OF MAKING DYNAMIC ABLATIVE NETWORKS, AND METHOD OF USING DYNAMIC ABLATIVE NETWORKS

(71) Applicant: University of Florida Research Foundation, Inc., Gainesville, FL (US)

(72) Inventors: Brent S. Sumerlin, Gainesville, FL (US); Kevin Anthony Stewart, Gainesville, FL (US); Daniel Delellis, Gainesville, FL (US); Jacob Lessard, Gainesville, FL (US); John Rynk, Gainesville, FL (US)

(21) Appl. No.: 19/124,418

(22) PCT Filed: Dec. 18, 2023
(86) PCT No.: PCT/US2023/084486

§ 371 Date: Apr. 25, 2025

Related U.S. Application Data
(60) Provisional application No. 63/434,222, filed on Dec. 21, 2022.
(60) Provisional application No. 63/472,696, filed on Jun. 13, 2023.

(51) Int. Cl. C08G 77/14

(52) U.S. Cl. CPC C08G 77/14

(57) ABSTRACT

The present disclosure provides for hybrid inorganic-organic vitrimers that contain an exceptionally high weight percent of polyhedral oligomeric silsesquioxane (POSS)-derivatives, methods of making hybrid inorganic-organic vitrimers, and methods of using hybrid inorganic-organic vitrimers. The polyhedral silsesquioxane (POSS)-derivatives can include alcohol functionalized POSS derivatives, ester functionalized POSS derivatives, and enaminone-crosslinked dynamic thermosets thereof from β-ketoester functionalized POSS cage derivatives. The present disclosure provides for methods of making hybrid inorganic-organic vitrimers including the alcohol functionalized POSS derivatives, the ester functionalized POSS derivatives, or the enaminone-crosslinked dynamic thermosets from β-ketoester functionalized POSS cage derivatives.

### CROSS-REFERENCE TO RELATED APPLICATIONS

This application claims priority to, and the benefit of, co-pending U.S. provisional application entitled “DYNAMIC ABLATIVE NETWORKS” having Ser. No. 63/434,222, filed Dec. 21, 2022; and this application claims priority to, and the benefit of, co-pending U.S. provisional application entitled “DYNAMIC ABLATIVE NETWORKS, METHODS OF MAKING DYNAMIC ABLATIVE NETWORKS, AND METHOD OF USING DYNAMIC ABLATIVE NETWORKS” having Ser. No. 63/472,696, filed Jun. 13, 2023; both of which are incorporated by reference in its entirety.

### STATEMENT REGARDING FEDERALLY SPONSORED RESEARCH OR DEVELOPMENT

This invention was made with government support under Grant No. 1904631, awarded by the National Science Foundation. The government has certain rights in the invention.

### BACKGROUND

Polymer materials such as thermoset polymers can provide impressive resistance to chemical exposure and possess dimensional, mechanical, and thermooxidative stability. However, current materials have drawbacks (e.g., material recycling and the ability to access complex shapes after synthesis) and there is a need to provide materials that overcome these drawback.

### SUMMARY

Briefly described, in various aspects, the present disclosure provides for hybrid inorganic-organic vitrimers that contain an exceptionally high weight percent of polyhedral oligomeric silsesquioxane (POSS)-derivatives, methods of making hybrid inorganic-organic vitrimers, and methods of using hybrid inorganic-organic vitrimers.

In an aspect, the present disclosure provides for a composition comprising: a hybrid inorganic-organic vitrimer having a weigh percent of a polyhedral silsesquioxane (POSS)-derivative of about 10 to 60 weight percent. In an aspect, the hybrid inorganic-organic vitrimer is a hybrid inorganic-organic enaminone vitrimer. In a particular aspect, the hybrid inorganic-organic vitrimer has the following structure:

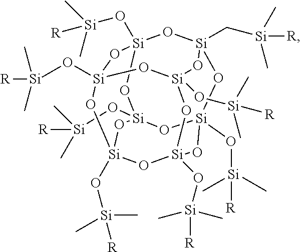

wherein each R is independently selected from:

| | Unbranched | Branched/Heteroatom/Polyol | Senzylic/Unsaturated | Phenolic/Unsaturated |
|---|---|---|---|---|
| R = | 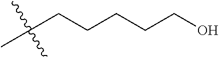 [SMILES: *CCCCCO] | 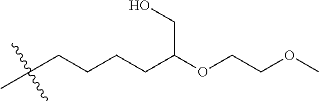 [SMILES: *CCCCC(CO)OCCOC] | 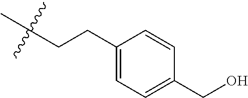 [SMILES: *CCc1ccc(CO)cc1] | 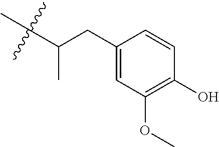 [SMILES: *C(C)Cc1ccc(O)c(OC)c1] |
| | 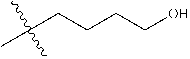 [SMILES: *CCCCO] | 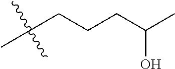 [SMILES: *CCCC(C)O] | 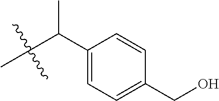 [SMILES: *C(C)c1ccc(CO)cc1] | 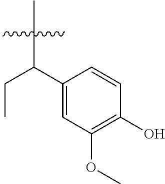 [SMILES: *C(CC)c1ccc(O)c(OC)c1] |
| | 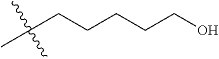 [SMILES: *CCCCCO] | 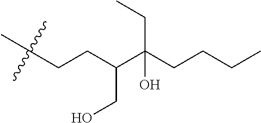 [SMILES: *CCC(CO)C(O)(CC)CCCC] | 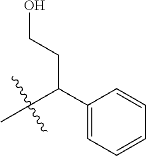 [SMILES: *C(CCO)c1ccccc1] | 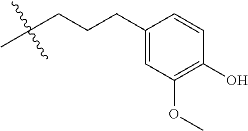 [SMILES: *CCCc1ccc(O)c(OC)c1] |
| | | 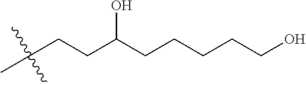 [SMILES: *CCC(O)CCCCCO] | 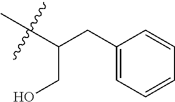 [SMILES: *C(CO)Cc1ccccc1] | 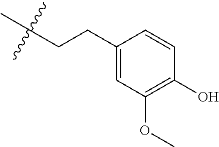 [SMILES: *CCc1ccc(O)c(OC)c1] |
| | | | | 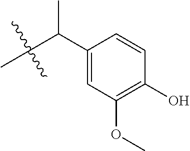 [SMILES: *C(C)c1ccc(O)c(OC)c1] |

The present disclosure provides for a method of making a hybrid inorganic-organic vitrimer having a weight percent of a polyhedral silsesquioxane (POSS)-derivative of about 10 to 60 weight percent, comprising:

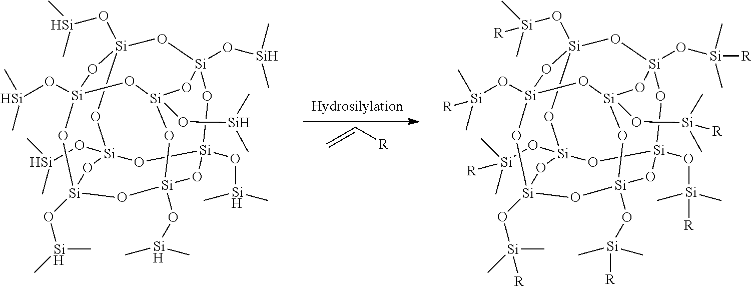

| | Unbranched | Branched/Heteroatom/Polyol | Benzylic/Unsaturated | Phenolic/Unsaturated |
|---|---|---|---|---|
| R = | 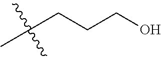 [SMILES: *CCCO] | 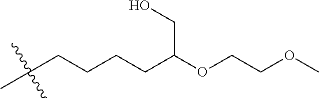 [SMILES: *CCCCC(CO)OCCOC] | 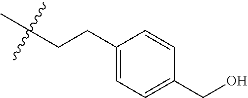 [SMILES: *CCc1ccc(CO)cc1] | 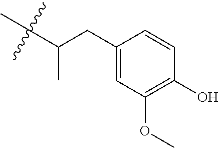 [SMILES: *C(C)Cc1ccc(O)c(OC)c1] |
| | 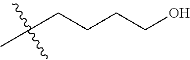 [SMILES: *CCCCO] | 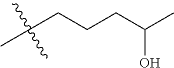 [SMILES: *CCCC(C)O] | 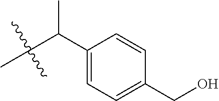 [SMILES: *C(C)c1ccc(CO)cc1] | 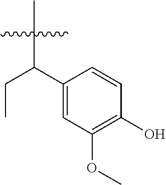 [SMILES: *C(CC)c1ccc(O)c(OC)c1] |
| | 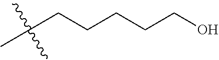 [SMILES: *CCCCCO] | 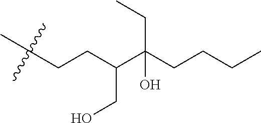 [SMILES: *CCC(CO)C(O)(CC)CCCC] | 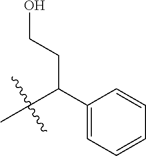 [SMILES: *C(CCO)c1ccccc1] | 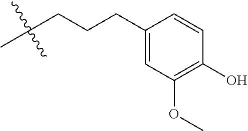 [SMILES: *CCCc1ccc(O)c(OC)c1] |
| | | 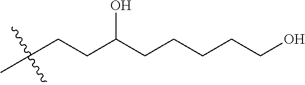 [SMILES: *CCC(O)CCCCCO] | 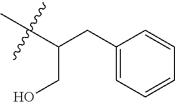 [SMILES: *C(CO)Cc1ccccc1] | 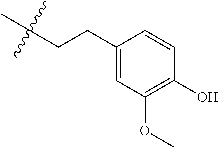 [SMILES: *CCc1ccc(O)c(OC)c1] |
| | | | | 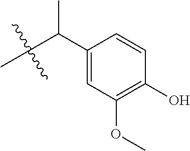 [SMILES: *C(C)c1ccc(O)c(OC)c1] |

The present disclosure provides for a method of making a hybrid inorganic-organic vitrimer having a weight percent of a polyhedral silsesquioxane (POSS)-derivative of about 10 to 60 weight percent, comprising:

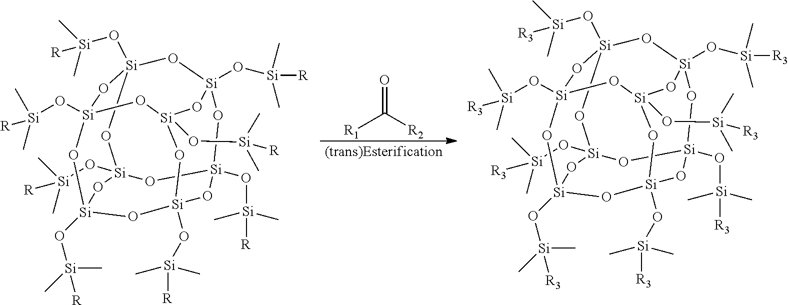

| | Acid/Acid Halide | | Activated Esters | | Traditional Esters | |
|---|---|---|---|---|---|---|
| R₁ = | 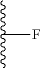 [SMILES: *F] | 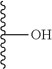 [SMILES: *O] | 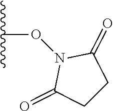 [SMILES: *ON1C(=O)CCC1=O] | 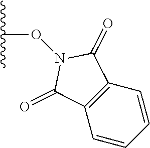 [SMILES: *ON1C(=O)c2ccccc2C1=O] | 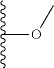 [SMILES: *OC] | 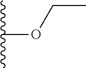 [SMILES: *OCC] |
| | 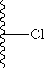 [SMILES: *Cl] | | 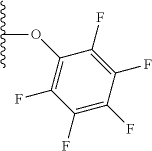 [SMILES: *Oc1c(F)c(F)c(F)c(F)c1F] | 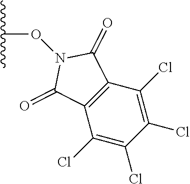 [SMILES: *ON1C(=O)c2c(Cl)c(Cl)c(Cl)c(Cl)c2C1=O] | 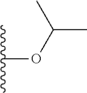 [SMILES: *OC(C)C] | 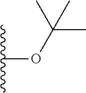 [SMILES: *OC(C)(C)C] |
| | 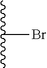 [SMILES: *Br] | | | | | |

| | | |
|---|---|---|
| R₂ = | Alkyl (branched, unbrached, unsaturated) | Acyl (where R₄ is a carbon atom; see below) |
| | Aryl (substituted or unsubstituted) (or) | 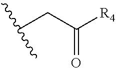 |

| | |
|---|---|
| R₃ = | Ester functional group where the proceeding carbon is a hydrocarbon chain that is saturated, |
| | unsaturated, branched, unbrached, heteroatom contaning, or an acyl group. Acyl group |
| | functionality is specified within the R₂ subject line above. |

The present disclosure provides for a method of making a hybrid inorganic-organic vitrimer having a weight percent of a polyhedral silsesquioxane (POSS)-derivative of about 10 to 60 weight percent, comprising:

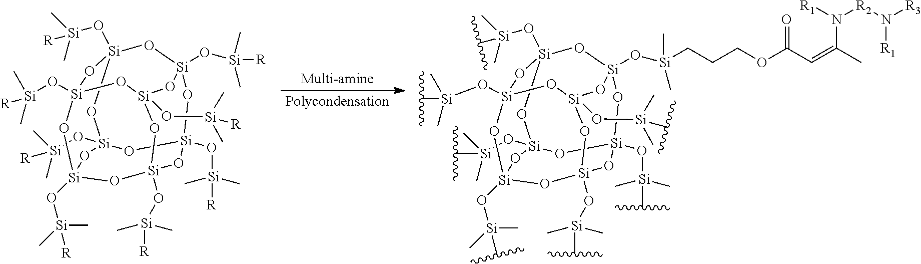

| | | Multi-Amine Spacer (Saturated Unbrached, Branched; Unsaturated; | | | |
|---|---|---|---|---|---|
| Starting Material | | Inorganic-Organic Hybrid; Heteroatom containing) | | | |
| R = | 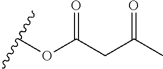 [SMILES: *OC(=O)CC(C)=O] | R₂ = | 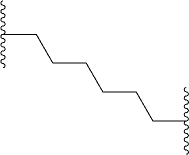 [SMILES: *CCCCCC*] | 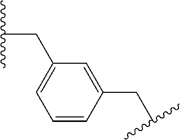 [SMILES: *Cc1cccc(C*)c1] | 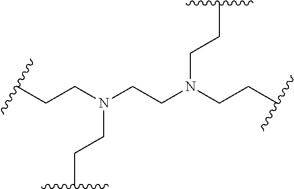 [SMILES: *CCN(CC*)CCN(CC*)CC*] |

| | | |
|---|---|---|
| Amine (Primary or Secondary) | 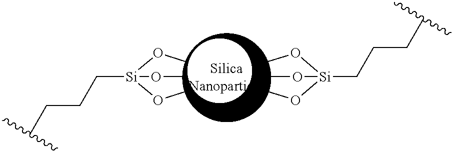 [SMILES: *CCC[Si](OC)(OC)OC ; *CCC[Si](OC)(OC)OC] | 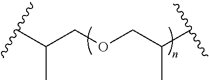 |

| | | |
|---|---|---|
| R₁ = | 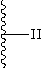 [SMILES: *[H]] | 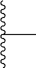 |
| | 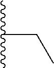 [SMILES: *CC] | 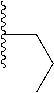 [SMILES: *CCC] |

| | |
|---|---|
| | Amine Terminus |
| R₃ = | A subsequent POSS monomer |
| | (or) |
| | R₁ |

### BRIEF DESCRIPTION OF THE DRAWINGS

Further aspects of the present disclosure will be more readily appreciated upon review of the detailed description of its various embodiments, described below, when taken in conjunction with the accompanying drawings. The components in the drawings are not necessarily to scale, emphasis instead being placed upon clearly illustrating the principles of the present disclosure.

FIG. 1.1 illustrates a general synthetic scheme for achieving alcohol functionalized POSS cage derivatives and selected functionalities thereof.

FIG. 1.2 illustrates a general synthetic scheme for achieving ester functionalized POSS cage derivatives and selected functionalities thereof.

FIG. 1.3 illustrates a general synthetic scheme for achieving enaminone-crosslinked dynamic network of POSS cage derivatives and selected functionalities of multi-amine crosslinkers.

FIG. 2.1 illustrates (top) a simplified diagram of the inside of solid rocket booster (SRB): fuel consumption causing heat front to propagate towards ablative HSM layer (orange cubes), causing pyrolysis (orange and black cubes) and eventual charring leading to inert, protective barrier (black cubes).

FIG. 2.2A-G illustrate X1 vitrimer formation and processing. FIG. 2.2A illustrates a scheme of network formation via condensation of POSS1 (β-ketoester functionalized cage with an aliphatic spacer) with difunctional amine m-xylyenediamine (XDA). FIG. 2.2B illustrates a POSS1 oil product before and FIG. 2.2C illustrates it after solubilizing in THF. FIG. 2.2D illustrates organogel formation 15 min after addition of XDA crosslinker. FIG. 2.2E illustrates vitrimer film after curing under vacuum at 85° C. for 6 h. FIG. 2.2F illustrates pulverized vitrimer shards before processing and FIG. 2.2G illustrates the reformed vitrimer after processing at 160° C. under vacuum).

FIG. 2.3A-C illustrates nanocomposite vitrimer characterization. FIG. 2.3A illustrates X-ray diffraction (XRD) patterns of POSS vitrimers showing amorphous character. FIG. 2.3B illustrates overlayed FTIR spectra of POSS1 (β-ketoester functionalized cage with aliphatic spacer) vitrimer crosslinked with m-xylyenediamine (X1) showing the characteristic stretches of the enaminone functional group and consumption of β-ketoester carbonyl. FIG. 2.3C illustrates stacked differential scanning calorimetry (DSC) plots with marked T_{g} values of POSS1 and (D) POSS2 (β-ketoester functionalized cage with an aromatic spacer) vitrimers.

FIG. 2.4A-C illustrates low-temperature (N₂) thermogravimetric analysis (TGA) plots of (FIG. 2.4A) POSS1 (β-ketoester functionalized cage with an aliphatic spacer) and POSS2 (β-ketoester functionalized cage with an aromatic spacer) cages crosslinked with m-xylyenediamine (X1 and 2, respectively); (FIG. 2.4B) hexamethylenediamine (H1 and 2, respectively) and (FIG. 2.4C) diaminododecane (FIGS. 2.4D1 and 2, respectively). TGA plots indicate that onset of degradation temperature (T_{d, 5%}) and char yield (plateau regions at 650° C.) are tunable by nature of POSS vertices (aliphatic versus aromatic) and diamine crosslinker.

FIG. 2.5 illustrates FTIR spectra of POSS1 (aliphatic spacer) cage crosslinked with diaminododecane (D1) vitrimer before after heating to 300, 650, and 1100° C. under atmospheric conditions (top to bottom, respectively).

FIG. 2.6A illustrates density of vitrimers as determined by Archimedes' test and FIG. 2.6B illustrates swelling ratios as determined by immersion in THF for 48 h.

FIG. 2.7A-F illustrates creep-recovery experiments for (FIG. 2.7A) X1, (FIG. 2.7B) H1, and (FIG. 2.7C) D1 vitrimers at 150° C. at a constant force of 5000 Pa (experiments ran in duplicate) showing excellent creep resistance and DMA thermograms of (FIG. 2.7D) X1, (FIG. 2.7E) H1, and (FIG. 2.7F) D1 vitrimers showing T_{g} values and constant rubbery plateau moduli.

FIG. 2.8A-B illustrates arrhenius plots of stress relaxation data for (FIG. 2.8A) POSS1 and (FIG. 2.8B) POSS2 vitrimers (τ at G/G₀=1/e, in 5° C. increments). Data indicates sluggish flow behavior, largely dependent on diamine functionality. Vitrimer samples were ran in duplicate.

FIG. 2.9 illustrates Scheme 1 and Chart 1.

FIG. 3.1A illustrates a ¹H-NMR FIG. 3.1B illustrates a ¹³C-NMR spectra of OP-POSS precursor.

FIG. 3.2 illustrates a ¹H-NMR spectrum of POSS1 monomer.

FIG. 3.3 illustrates a ¹H-NMR spectrum of synthesized 4-vinylbenzyl alcohol precursor.

FIG. 3.4 illustrates a ¹H-NMR spectrum of OBA-POSS precursor.

FIG. 3.5 illustrates a ¹H-NMR spectrum of POSS2 monomer.

FIG. 3.6 illustrates a FT-IR spectrum of POSS2 monomer.

FIG. 3.7 illustrates a FT-IR spectrum of POSS1 monomer.

FIG. 3.8 illustrates a high-temperature ramp TGA experiment (in N₂) of X1 vitrimer.

FIG. 3.9 illustrates a high-temperature ramp TGA experiment (in N₂) of H1 vitrimer.

FIG. 3.10 illustrates a high-temperature ramp TGA experiment (in N₂) of D1 vitrimer.

FIG. 3.11 illustrates a high-temperature ramp TGA experiment (in N₂) of X2 vitrimer.

FIG. 3.12 illustrates a high-temperature ramp TGA experiment (in N₂) of H2 vitrimer.

FIG. 3.13 illustrates a high-temperature ramp TGA experiment (in N₂) of D2 vitrimer.

FIG. 3.14 illustrates a first derivative plot of mass loss versus temperature of POSS1 vitrimers

### DETAILED DESCRIPTION

The present disclosure provides for hybrid inorganic-organic vitrimers that contain an exceptionally high weight percent of polyhedral oligomeric silsesquioxane (POSS)-derivatives, methods of making hybrid inorganic-organic vitrimers, and methods of using hybrid inorganic-organic vitrimers.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, material science, tribo-/rheology, and the like, which are within the skill of the art.

The following examples are put forth so as to provide those of ordinary skill in the art with a complete disclosure and description of how to perform the methods and use the compositions, methods, and materials disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

As used herein, the following terms have the meanings ascribed to them unless specified otherwise. In this disclosure, “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments.

### Definitions

By “chemically feasible” is meant a bonding arrangement or a compound where the generally understood rules of organic structure are not violated. The structures disclosed herein, in all of their embodiments are intended to include only “chemically feasible” structures, and any recited structures that are not chemically feasible, for example in a structure shown with variable atoms or groups, are not intended to be disclosed or claimed herein. However, if a bond appears to be intended and needs the removal of a group such as a hydrogen from a carbon, the one of skill would understand that a hydrogen could be removed to form the desired bond.

It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

The term “acyl” as used herein, alone or in combination, means a carbonyl or thiocarbonyl group bonded to one of the following, for example, optionally substituted, hydrido, alkyl (e.g. haloalkyl), alkenyl, alkynyl, alkoxy (“acyloxy” including acetyloxy, butyryloxy, iso-valeryloxy, phenylacetyloxy, berizoyloxy, p-methoxybenzoyloxy, and substituted acyloxy such as alkoxyalkyl and haloalkoxy), aryl, halo, heterocyclyl, heteroaryl, sulfonyl (e.g. allylsulfinylalkyl), sulfonyl (e.g. alkylsulfonylalkyl), cycloalkyl, cycloalkenyl, thioalkyl, thioaryl, amino (e.g alkylamino or dialkylamino), and aralkoxy.

Illustrative examples of “acyl” radicals are formyl, acetyl, 2-chloroacetyl, 2-bromacetyl, benzoyl, trifluoroacetyl, phthaloyl, malonyl, nicotinyl, and the like. The term “acyl” as used herein refers to a group —C(O)R₂₆, where R₂₆ is hydrogen, alkyl, cycloalkyl, cycloheteroalkyl, aryl, arylalkyl, heteroalkyl, heteroaryl, and heteroarylalkyl. Examples include, but are not limited to formyl, acetyl, cyclohexylcarbonyl, cyclohexylmethylcarbonyl, benzoyl, beozylcarbonyl and the like.

As used herein, “alkyl” or “alkyl group” refers to a saturated aliphatic hydrocarbon, which can be straight or branched, having 1 to 40, 1 to 20, 1 to 10, or 1 to 5 carbon atoms, where the stated range of carbon atoms includes each intervening integer individually, as well as sub-ranges. Examples of alkyl groups include, but are not limited to methyl, ethyl, n-propyl, i-propyl, n-butyl, s-butyl, t-butyl, n-pentyl, and s-pentyl. Reference to “alkyl” or “alkyl group” includes unsubstituted and substituted forms of the hydrocarbon moiety.

As used herein, “halo”, “halogen”, or “halide”, refers to a fluorine, chlorine, bromine, iodine, and astatine, and radicals thereof. Further, when used in compound words, such as “haloalkyl” refers to an alkyl or alkenyl radical in which one or more hydrogens are substituted by halogen radicals.

The term “aryl” also includes polycyclic ring systems (C₅-C₃₀) having two or more cyclic rings in which two or more carbons are common to two adjoining rings (i.e., “fused rings”) wherein at least one of the rings is aromatic, e.g., the other cyclic ring or rings can be cycloalkyls, cycloalkenyls, cycloalkynyls, aryls and/or heterocycles. Examples of heterocyclic rings include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3 b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl. One or more of the rings can be substituted as defined above for “aryl”.

The term “substituted aryl” as used herein includes an aromatic ring or a fused aromatic ring system consisting of no more than three fused rings at least one of which is aromatic, and where at least one of the hydrogen atoms on a ring carbon has been replaced by a halogen, an amino, a hydroxy, a nitro, a thio, an alkyl, a ketone, an aldehyde, an ester, an amide, a lower aliphatic, a substituted lower aliphatic, or a ring (aryl, substituted aryl, cycloaliphatic, or substituted cycloaliphatic). Examples of such include, but are not limited to, aminophenyl, hydroxyphenyl, chlorphenyl, and the like.

The term “heteroatom” means for example oxygen, sulfur, nitrogen, phosphorus, or silicon (including, any oxidized form of nitrogen, sulfur, phosphorus, or silicon; the quaternized form of any basic nitrogen or; a substitutable nitrogen of a heterocyclic ring) that includes chemically feasible bonding, where if the group bonded to the heteroatom is not defined, then it can be a hydrogen or alkyl group.

The term “unsaturated” refers to a molecule, such as a hydrocarbon or hydrocarbon moiety that includes one or more double bonds and/or triple bonds.

### Discussion

The present disclosure provides for hybrid inorganic-organic vitrimers that contain an exceptionally high weight percent (e.g., about 10 to 60 weight %)) of polyhedral oligomeric silsesquioxane (POSS)-derivatives, methods of making hybrid inorganic-organic vitrimers, and methods of using hybrid inorganic-organic vitrimers.

In an aspect, the polyhedral silsesquioxane (POSS)-derivatives can include alcohol functionalized POSS derivatives, ester functionalized POSS derivatives, and enaminone-crosslinked dynamic thermosets thereof from β-ketoester functionalized POSS cage derivatives. The present disclosure provides for methods of making hybrid inorganic-organic vitrimers including the alcohol functionalized POSS derivatives, the ester functionalized POSS derivatives, or the enaminone-crosslinked dynamic thermosets from β-ketoester functionalized POSS cage derivatives.

Thermoset materials sacrifice recyclability and reshapeability for increased chemical and mechanical robustness because of an immobilized, crosslinked polymeric matrix. The robust material properties of thermosets make them well-suited for applications such as heat-shielding materials (HSMs) or ablatives where excellent thermal stability, good mechanical strength, and high charring ability are paramount. Many of these material properties are characteristic of covalent adaptable networks (CANs), where the static connectivity of thermosets has been replaced with dynamic crosslinks. This dynamic connectivity allows network mobility while retaining crosslink connectivity to permit damage repair and reshaping that are traditionally inaccessible for thermoset materials.

The present disclosure provides for the synthesis of hybrid inorganic-organic vitrimers (e.g., hybrid inorganic-organic enaminone vitrimers) that contain an exceptionally high weight percent of polyhedral oligomeric silsesquioxane (POSS)-derivatives (caged or cage-like polysiloxane materials that have fused 8 member cyclosiloxane rings similar to cubane). The POSS silicon hydride materials hydrosilylate allyl/vinyl alcohols that then undergo esterification with β-ketoesters to give the correspondingf β-ketoester-containing POSS. Polycondensation of/l-ketoester-containing POSS with various diamine crosslinkers led to materials with facile tunability, shapeability, predictable glass transition temperatures, good thermal stability, and high residual char mass following thermal degradation. These features make thermosets exceptional candidates for high-performance materials in aerospace applications such as heat-shielding materials (HSMs). Furthermore, the char materials show notable retention of preordained shape following decomposition, suggesting their utility in the design of HSMs with complex detailing. Additional details are provided in Example 1.

As described above, the present disclosure includes hybrid inorganic-organic vitrimers such as hybrid inorganic-organic enaminone vitrimers. The weight percent of the polyhedral silsesquioxane (POSS)-derivative in the hybrid inorganic-organic vitrimer can be about 10 to 60 weight percent, about 30 to 55 weight percent, about 40-60 weight percent, or about 40-50 weight percent.

In an aspect, the hybrid inorganic-organic vitrimer can comprise the following structure:

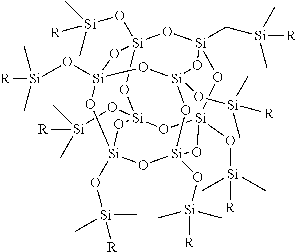

Each R can independently be selected from:

| | Unbranched | Branched/Heteroatom/Polyol | Benzylic/Unsaturated | Phenolic/Unsaturated |
|---|---|---|---|---|
| R = | 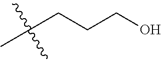 [SMILES: *CCCO] | 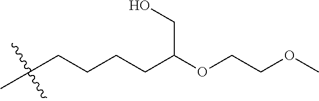 [SMILES: *CCCCC(CO)OCCOC] | 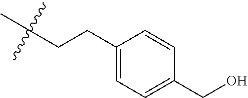 [SMILES: *CCc1ccc(CO)cc1] | 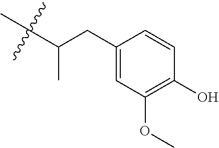 [SMILES: *C(C)Cc1ccc(O)c(OC)c1] |
| | 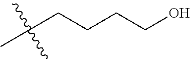 [SMILES: *CCCCO] | 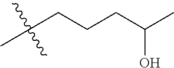 [SMILES: *CCCC(C)O] | 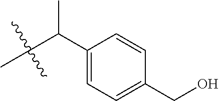 [SMILES: *C(C)c1ccc(CO)cc1] | 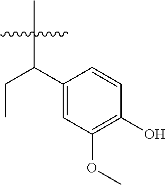 [SMILES: *C(CC)c1ccc(O)c(OC)c1] |
| | 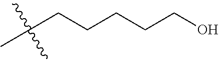 [SMILES: *CCCCCO] | 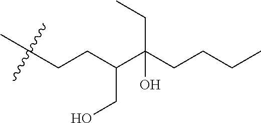 [SMILES: *CCC(CO)C(O)(CC)CCCC] | 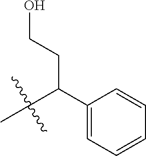 [SMILES: *C(CCO)c1ccccc1] | 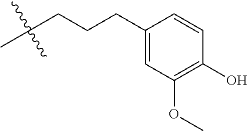 [SMILES: *CCCc1ccc(O)c(OC)c1] |
| | | 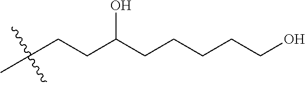 [SMILES: *CCC(O)CCCCCO] | 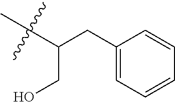 [SMILES: *C(CO)Cc1ccccc1] | 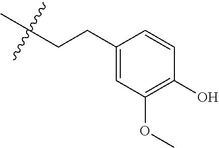 [SMILES: *CCc1ccc(O)c(OC)c1] |
| | | | | 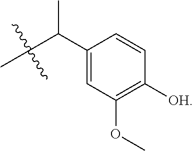 [SMILES: *C(C)c1ccc(O)c(OC)c1] |

In another aspect, two or more of the R groups can be the same. In an aspect, each R group is the same. In an aspect, about 50% to 100%, about 50% to 80%, about 70% to 90%, or about 80 to 90% of the R groups are the same. In an aspect, R is unbranched (see above). In an aspect, R is branched/heteroatom/polyol (see above). In an aspect, R is benzylic/unsaturated (see above). In an aspect, R is phenolic/unsaturated (see above).

In an aspect, the hybrid inorganic-organic vitrimer can comprise the following structure:

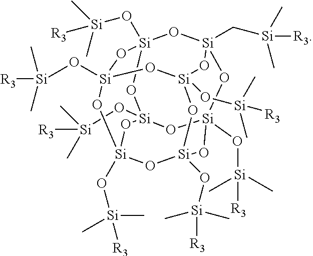

Each R₃ group can be an ester functional group with the proceeding carbon is a hydrocarbon chain having 1 to 10 or 1 to 6 carbons, where the hydrocarbon chain can be saturated or unsaturated, branch or unbranched, a heteroatom-hydrocarbon chain (the heteroatom being O, N, S, with an appropriate number of H atoms based on the heteroatom), or an acyl group (where the acyl group can be an alkyl group (saturated or unsaturated, branch or unbranched), an aryl group (substituted or unsubstituted), or a —C(H₂)—C(O)—R₄ (R₄ can be an alkyl group such as a C1 to C6 aklyl group).

In an aspect, the hybrid inorganic-organic vitrimer can comprise the following structure:

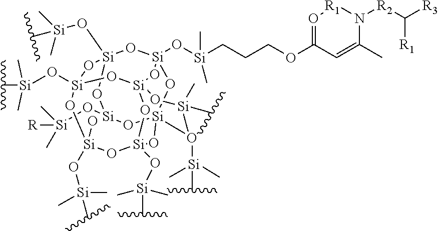

Each Si group can include two methyl groups as shown and the following group:

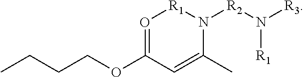

Each R1 group can be H or an alkyl group (C1 to C6 or C1 to C4 or C2 to C4). Each R2 group can be an alkyl group (e.g., a saturated or unsaturated, branch or unbranched C1 to C8 or C1 to C6 alkyl group) or spacer such as:

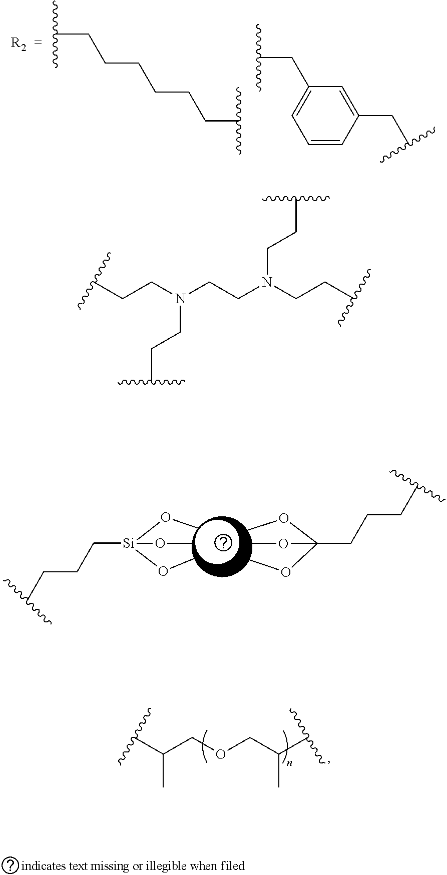

where the spacer group can be bonded to one or more hybrid inorganic-organic vitrimers. Each R₃ group can be an ester functional group with the proceeding carbon is a hydrocarbon chain having 1 to 10, where the hydrocarbon chain is saturated or unsaturated, branch or unbranched, a heteroatom-hydrocarbon chain, an acyl group, an aryl group, or a —C(H₂)—C(O)—R₄ (where the R₄ group is an alkyl group).

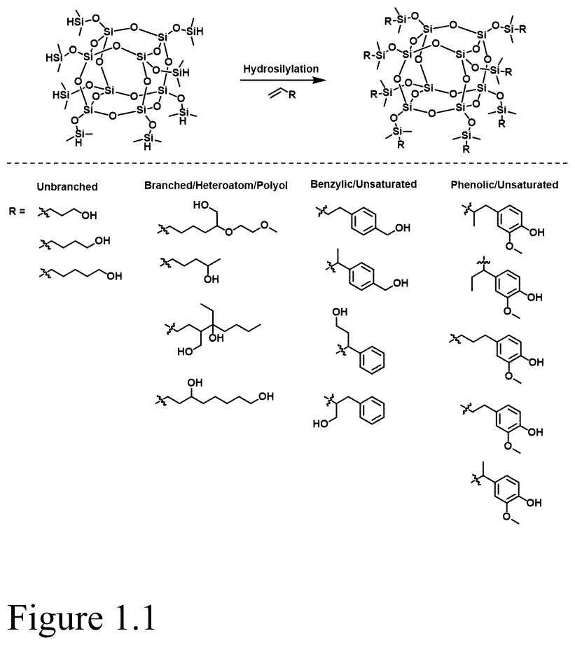

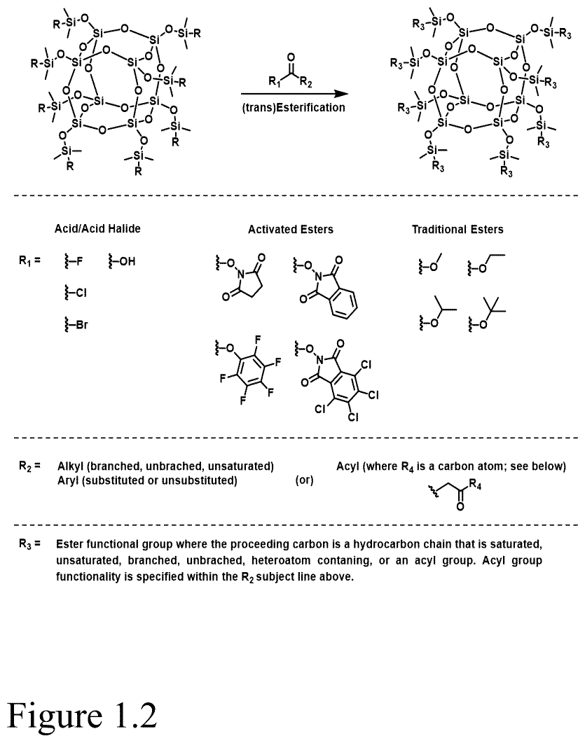

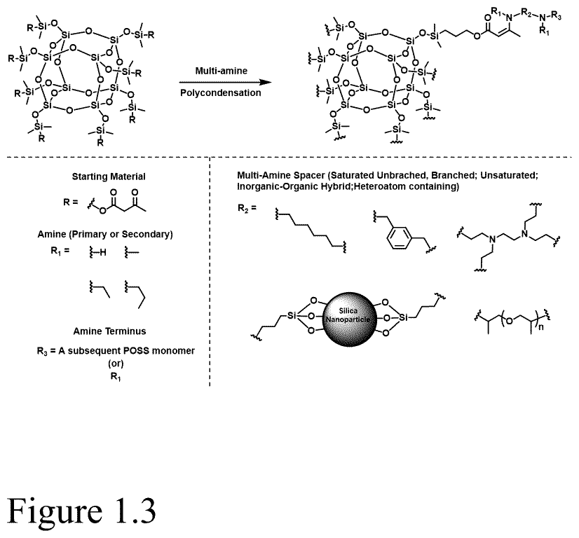

The following provide details regarding method of making various embodiments of the hybrid inorganic-organic vitrimers of the present disclosure. In an aspect, alcohol functionalized POSS derivatives can be made using the following method. The starting material (H-POSS) is subjected to hydrosilylation conditions with terminal or internal alkene-containing alcohol or polyol substrates to furnish POSS cage bearing primary, secondary, tertiary, benzylic, or phenolic alcohols attached to POSS cage vertices (FIG. 1.1). Hydrosilylation occurs with Markovnikov or anti-Markovnikov addition of Si—H bond across unsaturated bond. The reaction is catalyzed by general platinum(O) catalyst such as Spier's catalyst, Karstedt's catalyst, or Wilkerson's catalyst. A carbon chain/spacer between terminal silicon atom on cage vertices and alcohol(s) can be saturated, unsaturated, branched hydrocarbon. Oxygen heteroatoms can be within or without the carbon chain/spacer. (FIG. 1.1). The carbon chain/spacer for unbranched, saturated hydrocarbons can be between three and fifteen carbons or three to eight carbons. The carbon chain/spacer for unsaturated hydrocarbons can be between three and twenty carbons long or three to eight carbons long.

In an aspect, the ester functionalized POSS derivatives can be made using the following method. The starting material (alcohol functionalized POSS derivative vide supra) is subjected to esterification conditions with either: acid halide, carboxylic acid, activated ester, or primary, secondary, or tertiary ester (FIG. 1.2). The ester can contain saturated, unsaturated, or heteroatom containing functionality/substituents following the carbonyl carbon atom of the ester group directly bonded to the carbon chain/spacer attached to the POSS derivative. A β-ketoester can be installed onto the alcohol-containing POSS derivates via acid-catalyzed esterification of a separate β-ketoester containing molecule or thermolysis of a separate β-ketoester containing molecule (FIG. 1.2). The β-ketoester can contain an unsubstituted or substituted carbon alpha to the ester carbonyl. The final carbon on the β-ketoester skeleton (R₃) can be a single carbon or a carbon chain that is unbranched, branched, saturated, unsaturated, or contain heteroatoms. The R₄ group can be an alkyl group such as a C1 to C6 alkyl group.

In an aspect, the enaminone-crosslinked dynamic thermosets from β-ketoester functionalized POSS cage derivatives can be made using the following method. The starting material (β-ketoester functionalized POSS derivative vide supra) is subjected to step-growth polycondensation with a multi-amine hydrocarbon or inorganic-hydrocarbon hybrid compound (crosslinker). The multi-amine crosslinker can be comprised of primary or secondary amines (FIG. 1.3). The multi-amine crosslinker can contain between two or twelve amine moieties or two to eight moieties or two to six moieties. The multi-amine crosslinker can contain a saturated, unsaturated, branched, unbranched, or heteroatom containing carbon chain/spacer between amine moieties (FIG. 1.3).

### EXAMPLE

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLE

### Introduction

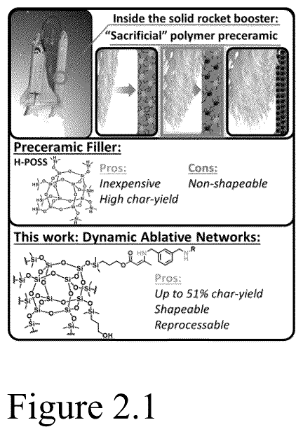

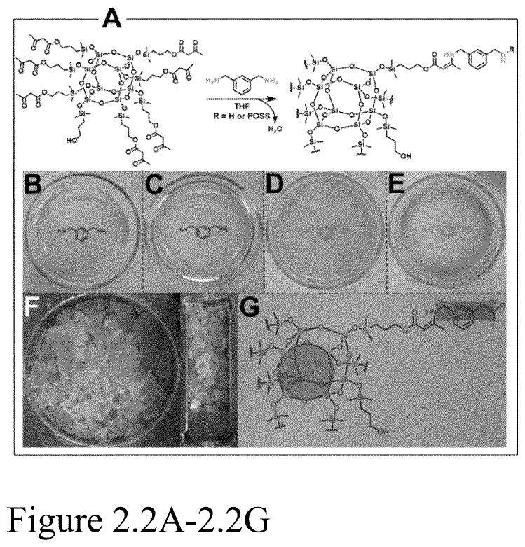

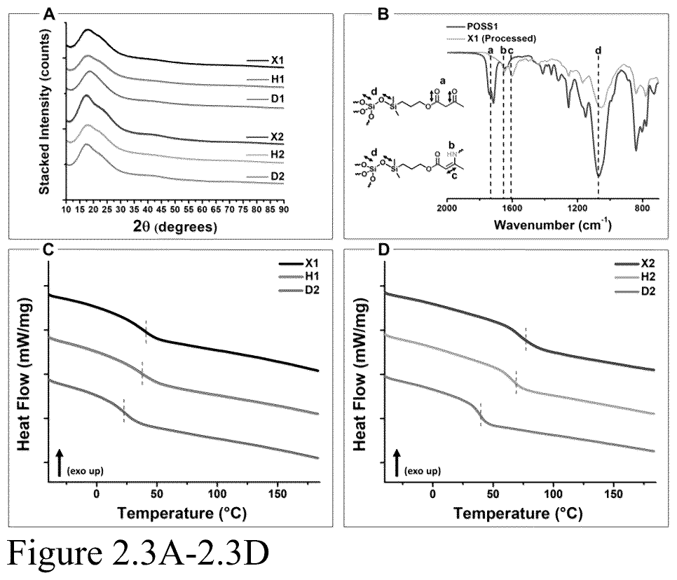

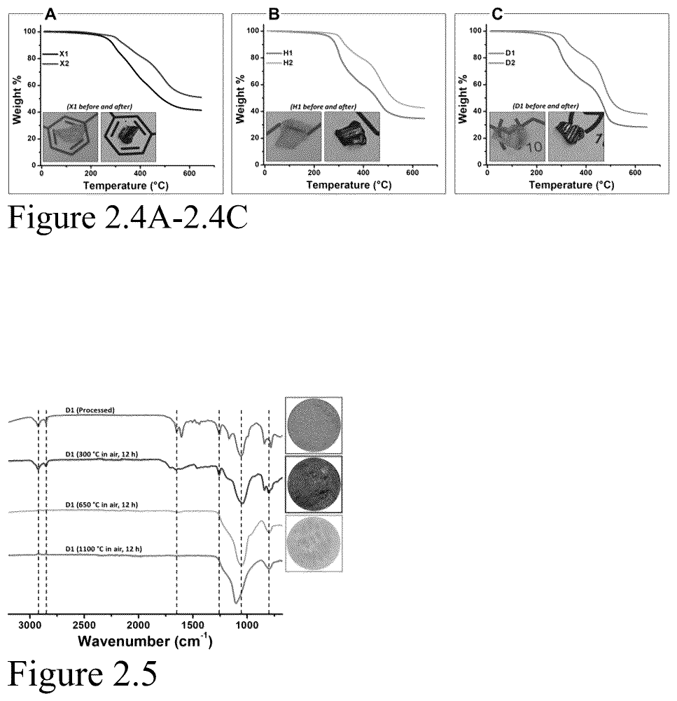

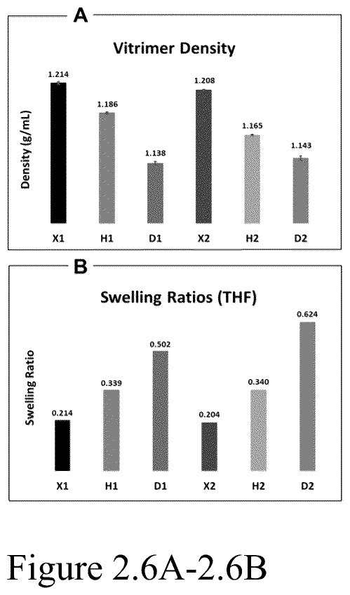

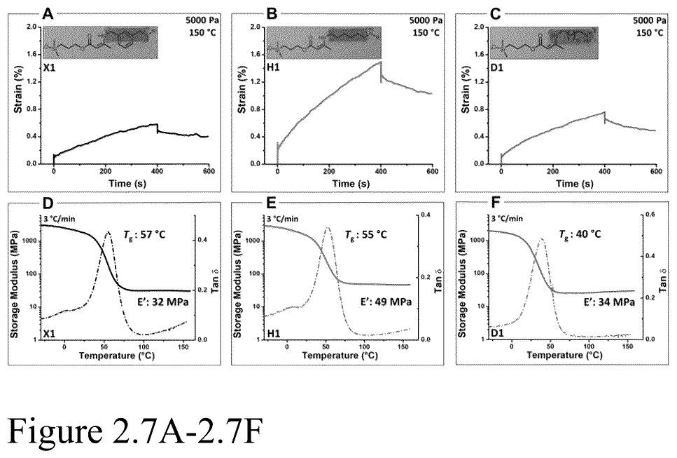

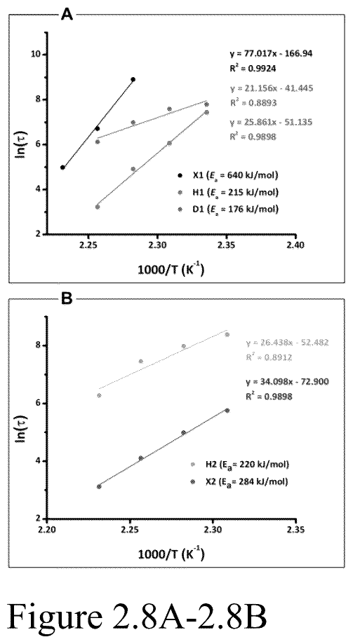

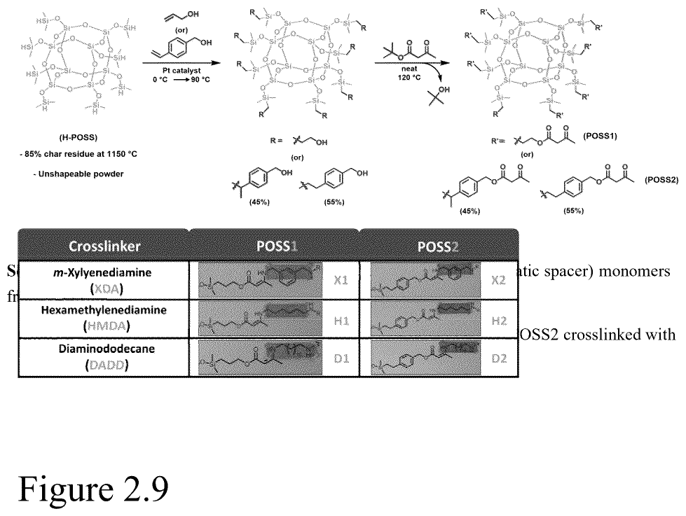

Owing to their permanently crosslinked structure, thermosets boast impressive resistance to chemical exposure and possess dimensional, mechanical, and thermooxidative stability.¹ These features make thermosets exceptional candidates for high-performance materials in aerospace applications such as heat-shielding materials (HSMs).²⁻⁵ HSMs are responsible for impeding the transmission of thermal energy to an underlying protected surface, such as the inner surface of a solid rocket motor casing or components near engines or heat zones (FIG. 2.1). HSMs must also be capable of withstanding normal operating and storage conditions, often for extended periods of time, prior to a thermal event.⁶ A variety of materials serve as the basis for such thermal protection systems, including metals, inorganic polymers or ceramics, and organic polymer intumescents or ablatives.⁷⁻¹¹ Polymeric ablative insulators impart thermal protection to an underlying layer by virtue of a discrete pyrolysis event that produces a residual and inert char layer that protects from further thermooxidative stress.¹² Some of the most utilized polymeric ablative insulators include phenolic resins, nitrile butadiene rubber (NBR), ethylene-propylene diene rubber (EPDM), and silicone elastomers.¹³⁻²⁰ These materials are typically loaded with a stabilizing filler (SiO₂, aramid or carbon fibers, and various ceramic precursors) to augment the material integrity before/during operational use and to boost the charring ability.²¹⁻²⁴ Although polymeric ablatives are typically thermoset materials, the intrinsic permanent structure of traditional crosslinked materials complicates both material recycling and the ability to access complex shapes after synthesis. Recent research in covalent adaptable networks (CANs) potentially allows such drawbacks to be mitigated.²⁵ CANs are polymer networks comprised of covalent crosslinks that are dynamic/reversible when exposed to a specific stimulus, the most common being heat. Upon introduction of heat and/or mechanical force (e.g., compression or shear), crosslink exchange dissipates thermal or mechanical energy through macroscopic flow.²⁶ These networks possess the robustness of thermosets while featuring the shapeability and recyclability of thermoplastics.²⁷ CANs are typically segregated into two distinct classes depending on their mechanism of crosslink exchange.²⁸ Dissociative CANs are governed by exchange in which crosslinks are in equilibrium with their individual reactive partners and the covalent adduct formed between them. Dissociative CANs typically,²⁹⁻³² though not always,^{33,34} demonstrate rapid decreases in viscosity at elevated temperatures. Associative CANs, often referred to as “vitrimers,” operate by a degenerate exchange reaction in which reactive moieties within the network react with existing crosslinks to form a new crosslink and liberate an identical reactive group.³⁵⁻³⁷ This process leads to predictable changes in viscosity and allows for crosslink density to be well maintained during (re)processing.

Vitrimers can operate by a wide variety of dynamic chemistries to afford associative crosslink exchange. However, many vitrimer chemistries require external catalysis to facilitate appreciably rapid exchange, potentially increasing the overall cost and decreasing the lifetime of the networks through catalyst degradation or leaching.³⁸⁻⁴² On the other hand, catalyst-free systems such as silyl ether exchange, dioxaborolane and imine metathesis, and transamination of enaminones accomplish facile bond exchange without the necessity of additives.⁴³⁻⁴⁸ Enaminone transamination has led to a burgeoning collection of vitrimer materials due to commercial availability or facile synthesis of β-ketoester-containing monomers and multi-amine building blocks.⁴⁹⁻⁵⁴ Recently, our group has capitalized on this exchange mechanism in combination with the straightforward synthesis of linear polymers containing 2-(acetoacetoxy)ethyl methacrylate (AAEMA), a reactive β-ketoester-containing monomer.^{55,56} Leveraging controlled radical polymerization, we have demonstrated that modifying the architecture and composition of crosslinkable macromolecular building blocks allows the rheological behavior of the final vitrimers to be tuned.^{57,58}

Despite the many advantages of CANs, the dynamic nature of their crosslinks can often result in mechanical properties that are inferior to static thermosets. Combining the dynamicity of vitrimers with the reinforcement of discrete fillers in composite materials has become an increasingly attractive platform for mitigating such drawbacks.^{59,60} Including fillers in typical commercial thermosets allows facile augmentation of material properties such as tensile strength, thermal stability, and thermal and electrical conductivity.^{61,62} Fillers including derivatized cellulose and chitosan, carbon fiber and carbon nanotubes, graphene, and silica nanoparticles have also been implemented into a variety of vitrimer materials.⁶³⁻⁷² Although these nanoparticle fillers improve certain material properties, factors such as filler content, efficient dispersion, and phase separation can be difficult to optimize. In many cases, there are diminishing returns on material enhancement, as high degrees of filler loading or filler incompatibility in the matrix can hinder efficient topological rearrangements of the vitrimer network.⁶⁰

Polyhedral oligomeric silsesquioxanes (POSS) are nanoscale inorganic cage-like molecules that serve as convenient frameworks for the production of nanocomposites and pre-ceramic polymers.⁷³⁻⁷⁹ Facile derivatization with organic substituents at the Si-vertices of POSS cages enables efficient dispersion in a range of polymeric matrices, with the rigid nanosilica core imparting thermochemical stability. Such features make POSS an appealing framework for fabricating vitrimers with high incorporation of inorganic fillers, thereby yielding materials that combine dynamicity with stability. However, POSS-based vitrimers have only recently garnered attention as promising platforms for composite CANs.⁸⁰⁻⁸³ Herein, we report the incorporation of novel β-ketoester-functionalized POSS cages to form nanocomposite vitrimers which, to the best of our knowledge, possess the highest weight percent POSS to date in vitrimer materials. The high degree of POSS crosslinked with various diamines led to vitrimers with tunable viscoelastic flow and glass transition temperatures (T_{g}), excellent creep resistance, and high-performance charring capabilities, potentially making these materials promising as HSMs with programmable shapes.

### Results and Discussion

### Synthesis and Characterization of POSS Derivatives and Nanocomposite Vitrimers.

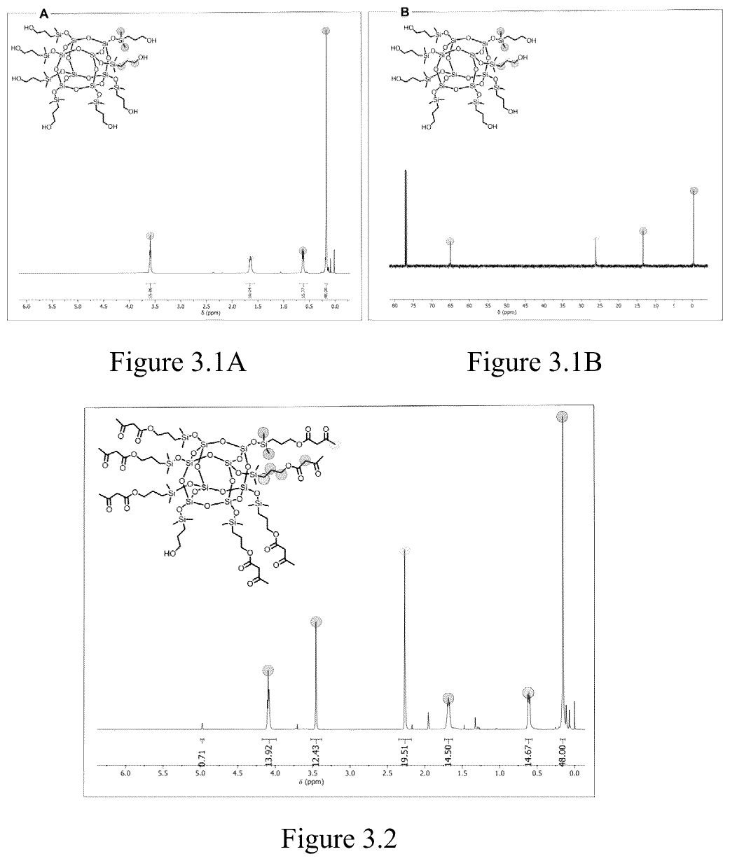

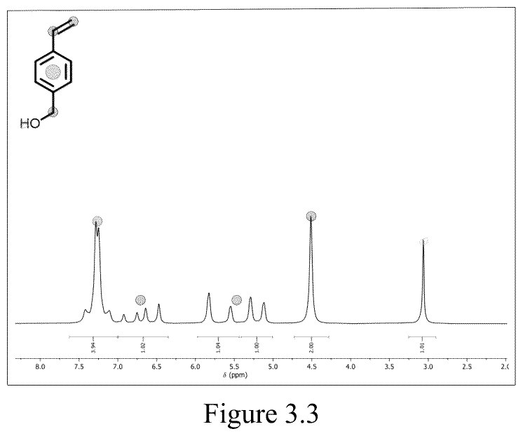

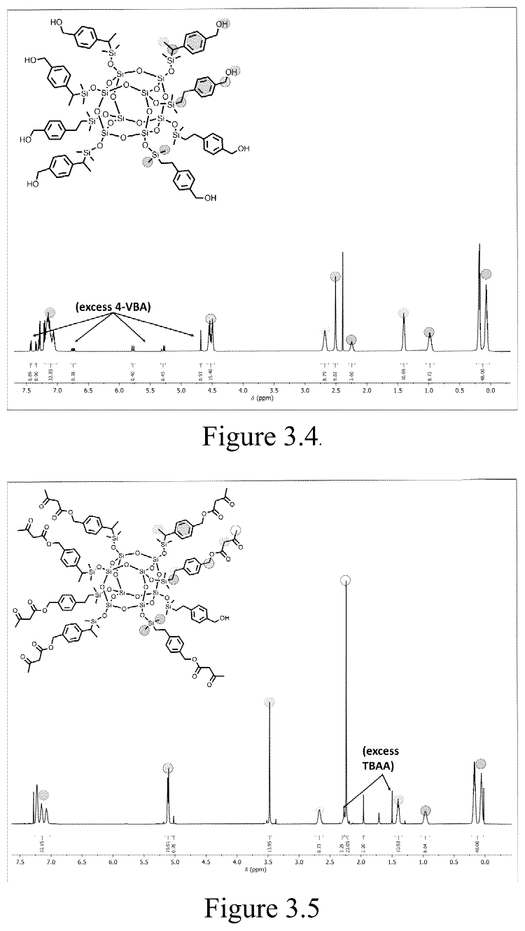

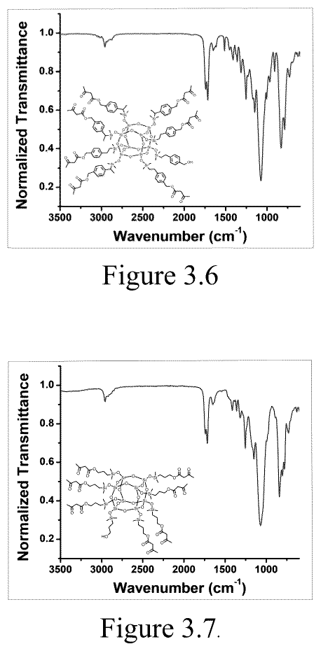

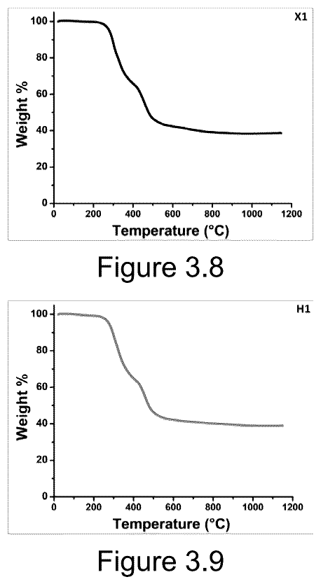

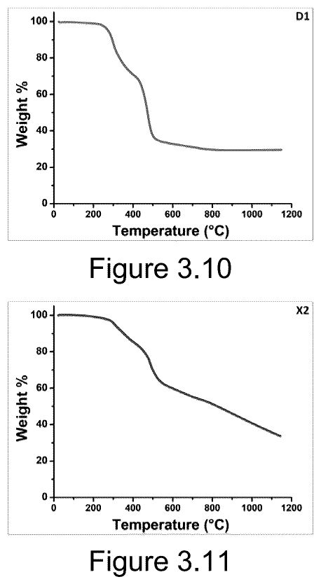

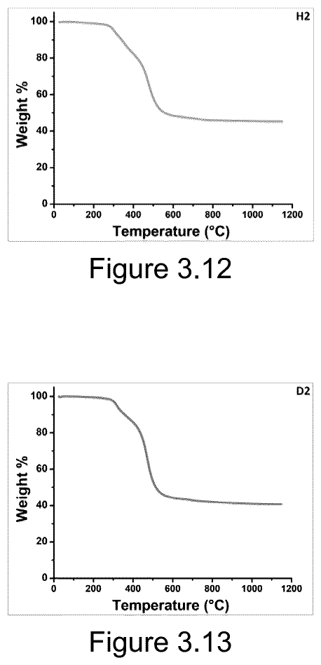

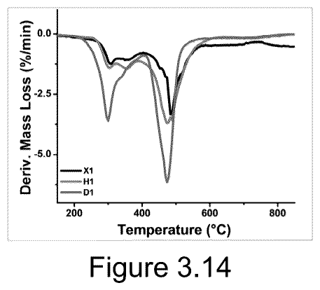

We sought to fabricate enaminone-crosslinked vitrimers while maintaining a high level of POSS filler content, anticipating this would result in vitrimers that could be easily shaped and reprocessed yet provide robust thermomechanical stability, features demonstrated by Liang and coworkers in their report on a dynamic covalent elastomer composite with excellent ablative properties.⁸⁴ We further hypothesized that with high POSS loadings these networks would provide significant char yields following pyrolysis. Therefore, POSS derivatives possessing multiple β-ketoester functional groups were synthesized to allow covalent incorporation of the inorganic cage into vitrimers using simple commercial diamines. The degree of functionality of the POSS precursor should lead to a dense step-growth network capable of high resistance to deformation at elevated temperatures, a necessity for potential HSM candidates. We envisioned that an aliphatic (propyl) or aromatic (benzyl) spacer could be integrated into β-ketoester POSS derivatives to allow for variability in thermomechanical properties of the vitrimer and overall char yield of the pyrolyzed material. To this end, nanocage monomers were prepared via a facile and high-yielding two-step synthesis from commercially available OctaSilane-POSS (H-POSS). While H-POSS is not strictly speaking a POSS cage, rather a Q₈M₈^{H} octadimethyl cubic silane, the ease of monomer synthesis is favorable over the hydrolytic condensation of trialkoxy-/chlorosilanes necessary to form true POSS cages. To prepare the two β-ketoester POSS cages, H-POSS was first subjected to platinum-catalyzed hydrosilylation with a slight excess of either allyl alcohol (POSS1) or 4-vinylbenzyl alcohol (POSS2) (FIG. 2.9 (Scheme 1) and FIGS. 3.1 and 3.4). The resultant neat viscous oils were then treated with tert-butylacetoacetate to furnish cages bearing, on average, seven β-ketoester groups, as determined by ¹H NMR analysis (FIGS. 3.2 and 3.5). Furthermore, FTIR spectroscopy indicated the absence of an —OH stretching band and the presence of a C=O stretching band from the β-ketoester functional groups (FIGS. 3.6 and 3.7).

The nanocomposite vitrimers were then prepared via step-growth polycondensation, crosslinking POSS1 or POSS2 with various diamines. Specifically, to investigate the consequences of diamine spacer length and flexibility on material properties, we prepared vitrimers X1 or 2 from m-xylylene diamine (XDA), H1 or 2 from hexamethylene diamine (HMDA), and D1 or 2 from diaminododecane (DADD), where the number 1 or 2 refers to materials prepared from POSS1 or POSS2, respectively (FIG. 2.9, Chart 1).

Since HSMs require robust dimensional stability at high operational temperatures, the]POSS derivatives were crosslinked with only 10 mol % excess of amine, providing network materials with appreciable shapeability and reprocessability yet sufficient resistance to deformation (creep) at elevated temperature. Vitrimers were synthesized in a straightforward solution-cast protocol from tetrahydrofuran and cured at 85° C. under reduced pressure. After curing, the vitrimers were broken into shards and compression molded into discs and bars at 160° C. under vacuum to give transparent and homogeneous materials (FIG. 2.2A-G).

X-ray diffraction (XRD) of the processed vitrimer discs showed a consistently amorphous broad peak in the range of 2Θ≈14.5-27° (FIG. 2.3A). The lack of distinct crystalline signals indicates that the nanofillers are homogenously distributed with minimal POSS-POSS cage interactions that could lead to aggregation or heterogeneity. The vitrimer films were then characterized by thermogravimetric analysis (TGA), differential scanning calorimetry (DSC), FTIR spectroscopy, dynamic mechanical analysis (DMA), and shear rheology. FTIR spectroscopy of all the vitrimers showed complete disappearance of the C=O stretching bands of the β-ketoester at ˜1725 cm⁻¹ and displayed the characteristic signals for the formation of enaminones at 181 1600 and ˜1650 cm⁻¹, corresponding to the C═C stretching and N—H bending, respectively. Additionally, retention of the signal at ˜1075 cm⁻¹ was observed in all cases, corresponding to POSS Si—O—Si stretching (FIG. 2.3B).

DSC analysis indicated that the T_{g} of the nanocomposites was indeed influenced by the functionality of the cage vertices and the nature of the diamine crosslinker (FIG. 2.3C-D). The T_{g} values of POSS1 vitrimers ranged from 23 to 39° C., while those of POSS2 vitrimers were higher, ranging from 39 to 73° C. The relatively similar length of the XDA and HMDA crosslinkers led to comparable T_{g} values for vitrimers prepared from POSS1 (39° C. and 37° C., respectively) and POSS2 (73° C. and 66° C., respectively). Since vitrimers made with HMDA displayed only slightly lower values of T_{g} than their XDA counterparts, we conclude that the observed differences in T_{g} values between POSS1 and POSS2 vitrimers are due to the higher degrees of freedom of the aliphatic spacer in the POSS1 precursors, resulting in an increase in segmental mobility of the polymer matrix. As expected, both D1 and D2, having been crosslinked with the longest and most flexible diamine, displayed dramatically lower T_{g} values (23° C. and 39° C., respectively). Notably, vitrimer D1 remained flexible at room temperature after compression molding. Selected properties of all vitrimer samples are shown in Table 1.

### Thermooxidative Stability and Shape Retention.

Thorough TGA studies were conducted to test the thermal stability of the POSS-containing vitrimers. The vitrimers were initially heated to a maximum temperature of 650° C. under an inert atmosphere to gain insight into the degradation profiles of the various formulations prior to complete ablation of carbon content. The POSS1 vitrimers displayed modest degradation temperatures (i.e., temperature at which 5% mass loss is reached, T_{d, 5%}) of 265, 267, and 256° C. and demonstrated char yields of 41, 35, and 28% for X1, H1, and D1, respectively (FIG. 2.4A-C). Multiple modes of degradation were evidenced for the POSS1 aliphatic derivatives. Gratifyingly, the final char material for POSS1 vitrimers appeared to retain the distinct shape of the sample prior to decomposition. D1 seemed to show the best retention of detail despite its overall decrease in volume and mass loss. As expected, the increased aromatic character of the POSS2 formulations affected both the T_{d, 5%} and char yield, with onset temperatures of 305, 305, and 312° C. and char yields of 51, 43, and 38% for X2, H2, and D2, respectively (FIG. 2.4A-C).

TABLE 1
Selected preliminary properties of POSS vitrimers

| | Storage | | | | | |
|---|---|---|---|---|---|---|
| | Modulus | | | | Char Yield | Inorganic [symbol] |
| | at 160° C. | T [symbol] _{DS} [symbol] | T [symbol] _{DMA} | T [symbol] | at 650° C. | POSS |
| Sample | (MPa) | (° C.) | (° C.) | (° C.) | (N [symbol] ) (%) | Content (wt %) |
| X1 | 32 | 39 | 57 | 265 | 41 | 54 |
| H1 | 49 | 37 | 55 | 267 | 35 | 55 |
| D1 | 34 | 23 | 40 | 256 | 28 | 41 |
| X2 | 18 | 73 | 76 | 305 | 51 | 40 |
| H2 | 27 | 66 | 75 | 305 | 43 | 43 |
| D2 | 16 | 39 | 56 | 312 | 38 | 34 |

[symbol]

indicates data missing or illegible when filed

We next extended the thermal stability studies beyond 1000° C., conditions more relevant to potential HSM applications. For all of the vitrimers, heating to 1150° C. in a dual TGA/DSC experiment (under N₂) displayed no appreciable change in the final char yield as compared to the preliminary thermal stability tests (FIGS. 3.8-3.13), and the materials again showed similar retention of the original shape. The POSS1 materials possessed two distinct decomposition modes (FIG. 3.14). The first decomposition mode was similar between X1 and H1, with D1 being the most pronounced in both rate and magnitude of decomposition, a consequence of higher aliphatic carbon content and resulting lower network density. Such molecular features clearly govern the final char yield of the materials under inert atmosphere. Furthermore, all POSS1 vitrimers showed DSC thermograms with three distinct exotherms. The first and smallest occurs at approximately 300° C., where the decomposition of bare H-POSS begins (T_{d}=309° C.), as well as the approximate start of the onset temperatures of the POSS1 vitrimers. This is likely attributable to thermal cracking of the POSS core and subsequent crosslinking of Si—O residues.⁸⁵ The second and larger exotherms all occur roughly at 450° C. (nearly the same as the onset of the second decomposition), a result of carbonization of the organic component of the network. The most pronounced exotherm occurred at approximately 600-700° C., likely a crystallization event leading to a carbonaceous amorphous glass. The high-temperature TGA results for POSS2 vitrimers mostly agree with the lower temperature results; however, X2 displays a slow but constant degradation profile, lacking any distinct exotherms in comparison to all other formulations. In fact, the char yield at 1150° C. is lower than its POSS1 counterpart. The comparatively higher aromatic content in X2 leads to an extended carbonization event. H2 and D2 again showed increased T_{d} and char yields compared to H1 and D1, with comparable exotherms occurring slightly higher at 700-800° C.

The atmospheric stability of the vitrimers was tested at temperatures up to 1100° C. Each sample was placed on an alumina plate in air and heated to the designated temperature at 10° C./min. The samples were held at the designated temperature for 12 h before natural cooling to room temperature (the furnace was turned off but left closed). Relying on the previously obtained TGA/DSC data, each sample was heated at 300, 650, and 1100° C. After heating to 300° C., all samples became black and shrunk in size, with some curling at the edges. POSS1 vitrimers appeared to retain the pattern from the Teflon tape used during compression molding, again with D1 appearing to have the best retention as seen in preliminary TGA studies. Moreover, no notable change in size was observed after the 650° C. or 1100° C. exposures. All formulas were brittle after the 650° C. exposure, however, the small, tough crystals remained difficult to crush for FT-IR analysis after treatment at 650° C. and 1100° C.

Irrespective of which POSS monomer or diamine was used for the nanocomposite vitrimer, the nanofiller cage seemingly allows for stabilization of the organic content over long heating periods as well as predictable char yields. Yet, TGA results suggest that X2 is a slight outlier in that there are diminishing returns on aromatic content; the char material lacked any plateau in weight percent or distinct exotherm near 600-700° C. in the DSC thermogram. We hypothesize that the increased aromatic character results in significantly higher carbon content remaining present at these temperatures, disrupting the crystallization events occurring in the other vitrimer samples that leads to the final inert char as evidenced by clear plateaus.

FT-IR analysis of D1 over the course of the heating process showed clear evidence for the formation of an amorphous glass. After 12 h at 300° C., the material showed distinct C—H stretching signals overlapping with the virgin materials as well as a subtle, broad absorption at approximately the frequency of the enaminone functional groups. After 12 h at 650° C., the material was nearly completely white and consequently all organic signals were lost in the IR spectrum. Interestingly, after the treatment at 1100° C., the Si—O stretching showed a minor shift to a higher wavenumber, potentially indicating a new phase of the amorphous silica. Silica is a complex polymorph that demonstrates a variety of glassy and crystalline phases with some overlap of temperature ranges.⁸⁶ However, given the long dwell time at 300, 650, and 1100° C., we expect that tridymite, quartz, and cristobalite, respectively, are the most likely phases to be present, though more in-depth DSC and XRD analysis is required.

### Vitrimer Density and Mesh Size Determination.

Nanocomposite vitrimer density was measured (×3) by Archimedes' principle using Equation S1 (FIG. 2.8A. A clear relationship was observed between the vitrimer densities and the length and flexibility of the diamine crosslinker, where densities range from 1.214 to 1.138 g/mL for POSS1 samples and 1.208 to 1.143 g/mL for POSS2 samples (FIG. 2.6A).

To validate the measured density values for the vitrimers, the samples were then swollen in THF for 48 h, and the solvent was removed and replenished after 24 h (other solvents tested such as ethanol, methanol, and diethyl ether gave no appreciable swelling after 48 h). The swelling ratios were notably small for all vitrimers, offering further evidence of their highly densified network structure (FIG. 2.6B). Gratifyingly, the trends in swelling ratios were consistent with the measured densities and indicated a predictable inorganic network density that scaled inversely with the length/flexibility of the diamine crosslinker. In addition to their shapability, the density of these materials (comparable to PMMA) and their solvoresistance potentially make them attractive materials for lightweight, weather-resistant thermal protective barriers.

### Rheological Properties.

The thermomechanical properties of the nanocomposite vitrimers were evaluated by DMA. Crosslinked networks were evidenced by the rubbery plateaus observed in all DMA thermograms, displaying constant crosslink density over a 100° C. range past T_{g} for all POSS1 and POSS2 samples (FIG. 2.7D-F, respectively). Markedly, the rubbery plateau modulus was exceptionally high for all POSS1 vitrimers, indicating that the network structures were notably dense, a consequence of the high connectivity and rigidity of the POSS cage repeat unit. Typically, an increase in crosslink density—observed by an increase in the storage modulus)(E′) of the rubbery plateau—corresponds with a rise in T_{g} as the segmental mobility of the polymer is restricted. The T_{g} of the vitrimers determined by DMA and DSC exhibited a strong dependence on the length and flexibility of the diamine crosslinker, decreasing slightly from the XDA vitrimers to HMDA vitrimers and more dramatically for the vitrimers crosslinked with the lengthy dodecyl spacer of DDAA. Interestingly, the E′ of X1 did not trend as expected, resulting in the lowest E′ of the three POSS1 vitrimers even though X1 contained the shortest and most rigid crosslinker. We hypothesize that the higher degrees of freedom/flexibility of the aliphatic diamines could lead to loop catenations of crosslinks, artificially increasing the observed crosslink density.

Resistance to deformation at elevated temperatures was evaluated by conducting creep-recovery experiments at 150° C. under 5 kPa of force. The vitrimers all displayed excellent resistance to the applied deformation. After 400 s, the POSS1 vitrimers reached maximum strains of 0.58, 1.5, and 0.77% and had similar recoveries of 31, 30, and 35% for X1, H1, and D1, respectively (FIG. 2.7A-C). The POSS2 materials also displayed similar resistance to creep, reaching maximum strains of 1.4, 1.3, and 1.6% for X2, H2, and D2, respectively. However, the elasticity of H2 and D2 was markedly pronounced, showing a dramatic increase in deformation followed by an instantaneous rebound of the material before entering the viscous flow regime. Moreover, the apparent recovery was significantly higher than the POSS1 counterparts and appeared to scale similarly to the extent of the initial elastic deformation.

Stress relaxation experiments were conducted to probe the temperature sensitivity (or energy of activation for viscous flow, Eₐ) of the vitrimer networks. Given the creep data, we were unsurprised to observe extremely long characteristic relaxation times (τ, time when G/G₀=1/e). We applied stress-relaxation data to Arrhenius' law, assuming a single Maxwell model, by plotting ln(τ) versus inverse temperature and extracted Eₐ from the slope (Equation S2). POSS1 vitrimers had disparate Eₐ values of 640., 215, and 176 kJ/mol for X1, H1, and D1, respectively (FIG. 2.11A). These data indicate that the temperature sensitivity of the nanocomposite vitrimers (comparable to magnitude of Eₐ and the slope of the linear regression fit) corresponds to the nature of the diamine (length and rigidity/flexibility). Furthermore, the much higher Eₐ values for these vitrimer composites compared to previously reported enaminone vitrimers confirm a dramatic decrease in flow behavior as a result of the dense network composition and structural rigidity of the POSS nanocage. It is worth noting that X1 could only be plotted with three temperature points due to inability to reach its characteristic relaxation time below 165° C. Furthermore, the data points for D1 deviate from linearity, indicating complex flow behavior that does not obey an Arrhenius relationship. Similarly sluggish stress relaxation was demonstrated by the X2 and H2 vitrimers (FIG. 2.111B) while D2 failed to reach its characteristic relaxation time below 175° C.

The particularly high weight percent of inorganic filler, the high degree of functionality of the POSS cages, and the low mol % excess amine led to dramatically perturbed vitrimer flow behavior. These results suggest there may be limitations to filler weight percent in dynamic nanocomposites. Nevertheless, flow could potentially be enhanced by increasing the excess amine content. Typically, this would be seen as a considerable drawback for a vitrimer system. However, considering the harsh (deformative force and/or elevated temperatures) and long-term storage conditions HSMs are subjected to, these vitrimers may be ideal for use as thermal protective barriers.

### Reprocessability and Mild Chemical Degradation.

To evaluate the reprocessability of the networks, we conducted DMA studies to measure the E′ and T_{g} of bars of the virgin networks that were broken and healed up to four times for the POSS1 vitrimers. The first two reprocess cycles (R×1 and R×2) were conducted at 160° C. and the second two (R×3 and R×4) at 175° C., due to the increase in T_{g} after two cycles. Values of the plateau storage modulus were extrapolated from the rubbery plateau region of the thermogram, and values of T_{g} were measured at the peak of tan(S). X1 showed a slight increase in both T_{g} and rubbery plateau modulus over reprocessing cycles, likely a result of amine oxidation and subsequent loss of the productive species for exchange. H1 showed the least consistent reprocessability with variability in T_{g} and E′ across healing cycles. Gratifyingly, D1 showed good reprocessability, with only a moderate increase in the T_{g} and good retention of the original E′ over each healing cycle.

The reprocessability of the POSS2 vitrimers was less notable than that of POSS1, as efficient healing could only be achieved three times for X2, two times for H2, and once for D2. X2 showed the most variability in T_{g} and E′ while crosslink integrity for H2 and D2 showed good retention of both. The reprocessed bars appeared to have only relatively minor defects accumulating with each reprocess cycle and retained good transparency. FTIR analysis of reprocessed bars of both POSS1 and POSS2 vitrimers were near identical with the virgin material, indicating retention of the enaminone functional group and inorganic cage. We suspect the lability of the benzylic carbon of the ester could be contributing to the marked decrease in reprocessability of the POSS2 vitrimers, which could be a site for permanent crosslink formation via S_{N}2 displacement by free amines.

Another attractive feature of dynamic covalent networks is the potential for chemical degradation and recycling. The enaminone bond has been shown to degrade efficiently in the presence of excess monofunctional amine.^{55,56} Additionally, the bond is hydrolytically labile under acidic conditions.⁸⁷ Therefore, we chose X1 to observe mild degradation by both methods. No swelling or dissolution was observed when a disk of X1 was submerged in THF for 48 h. Addition of either hexylamine or aqueous HCl resulted in the vitrimers being near completely solubilized with trace amounts of intractable solids. These results suggest the POSS nanocomposite vitrimers can also be effectively degraded under mild conditions, allowing for facile end-of-life management and potential chemical recycling.

### CONCLUSIONS

Nanocomposite vitrimers are an emerging platform for fabricating dynamic covalent networks with enhanced material properties, thermooxidative stability, and reprocessability. Until recently, POSS-based vitrimers have found only limited use as scaffolds for designing such nanocomposites. These results demonstrate new routes for the synthesis and utility of multi-functional β-ketoester-POSS nanocages for the fabrication of novel nanocomposite enaminone vitrimers of diverse architectures. The final vitrimer properties can be tuned by virtue of the POSS-vertex functionality (aliphatic versus aromatic) and the choice of multi-amine crosslinker. Indeed, the structure-property relationships elucidated in these studies indicate that vitrimer materials can be specifically designed for rapid reprocessability to give largely defect-free films with excellent transparency, thermal stability, char yield, programmable T_{g}, and facile shapeability. Following thermal degradation up to 650° C. in N₂ and 300° C. in air, the final char materials showed marked retention of the imprinted shape of the parent material. Moreover, their complex network structure endowed the networks with a strong resistance to deformation at elevated temperature. One caveat, however, is that the remarkably high weight percent of POSS filler may retard relaxation of shear stress, indicating a threshold above which flow behavior is particularly hampered. The thermomechanical behavior of these POSS vitrimers is under continued investigation, but given our initial findings, we believe these nanocomposite vitrimers could serve as a useful platform for designing heat-shielding materials capable of facile shapeability.

### REFERENCES

(1) Long, T. E. Toward Recyclable Thermosets. Science 2014, 344, 706-707.
(2) George, K.; Panda, B. P.; Mohanty, S.; Nayak, S. K. Recent Developments in Elastomeric Heat Shielding Materials for Solid Rocket Motor Casing Application for Future Perspective. Polym. Adv. Technol. 2018, 29, 8-21.
(3) L. Pilato, Phenolic Resins: A century of Progress, Springer, Berlin, 2010.
(4) Youren, J W. Ablation of Elastomeric Composites for Rocket Motor Insulation. Composites 1971, 2,180-184.
(5) Natali, M.; Kenny, J. M.; Torre, L. Science and Technology of Polymeric Ablative Materials for Thermal Protection Systems and Propulsion Devices: A Review. Prog. Mater Sci. 2016, 84, 192-275.
(6) Donskoy, A. Elastomeric Heat-Shielding Materials for Internal Surfaces of Missile Engines. Int. J. Poly. Mater 1996, 31, 215-236.
(7) Natali, M.; Monti, M.; Puglia, D.; Kenny, J. M.; Torre, L. Composites: Part A Ablative Properties of Carbon Black and MWNT/Phenolic Composites: A Comparative Study. Compos. PartA. 2012, 43, 174-182.
(8) Nayak N V. Composite Materials in Aerospace Applications. Int. J Sci. Res. Publ. 2014, 4, 1-10.
(9) Qu, H.; Hui, K.; Bian, C.; Guan, Y.; Li, H.; Luan, T.; Yan, N. Lightweight and Mechanically Robust EPDM Foams for High Thermal Insulation and Moderate Ablative Resistance Via Constructing Cellular Char Layer. Macrol. Mater Eng. 2022, 2100665, 1-10.
(10) Moore, L. M. J.; Greeson, K. T.; Stewart, K. A.; Kure, D. A.; Corley, C. A.; Jennings, A. R.; Iacono, S. T.; Ghiassi, K. B. Perfluoropyridine as a Scaffold for Semifluorinated Thiol-Ene Networks with Readily Tunable Thermal Properties. Macromol. Chem. Phys. 2020, 221, 1-5.
(11) Zirmstein, B.; Schulze, D.; Schartel, B. The Impact of Polyaniline in Phosphorus Flame Retardant. Thermochim. Acta. 2019, 673, 92-104.
(12) Carlos, J.; Amado, Q.; Ross, P. G.; Sanches, N. B. Evaluation of Elastomeric Heat Shielding Materials as Insulators for Solid Propellant Rocket Motors: A Short Review. Open Chem. 2020, 1452-1467.
(13) Li, J.; Hu, B.; Hui, K.; Li, K.; Wang, L. Effects of Inorganic Nanofibers and High Char Yield Fillers on Char Layer Structure and Ablation Resistance of Ethylene Propylene Diene Monomer Composites. Compos. Part A. 2021, 150, 106633.
(14) Kabra, S., Tandon, S., & Kandasubramanian, B. POSS Nanocomposites for Defense and Space Applications. In Polyhedral Oligomeric Silsesquioxane (POSS) Polymer Nanocomposites. 2021, 481-498.
(15) Gao, G.; Zhang, Z.; Li, X. An Excellent Ablative Composite Based on PBO Reinforced EPDM. Polym. Bull. 2010, 64, 607-622.
(16) Jia, X.; Zeng, Z.; Li, G.; Hui, D.; Yang, X.; Wang, S. Enhancement of Ablative and Interfacial Bonding Properties of EPDM Composites by Incorporating Epoxy Phenolic Resin. Compos. Part B. 2013, 54, 234-240.
(17) Singh, S.; Guchhait, P. K.; Bandyopadhyay, G. G.; Chaki, T. K. Development of Polyimide—Nanosilica filled EPDM Based Light Rocket Motor Insulator Compound: Influence of Polyimide—Nanosilica Loading on Thermal, Ablation, and Mechanical Properties. Compos. Part A. 2013, 44, 8-15.
(18) Ahmed, A. F.; Hoa, S. V. Thermal Insulation by Heat Resistant Polymers for Solid Rocket Motor Insulation. J. Compos. Mater. 2011, 46, 1549-1559.
(19) Daly, J. H., Harts, W. A., Meyer, D. A., & Sommer, J. G. Nitrile-butadiene Rubber in Ablative Appliation. Appl. Polym. Symp. 1974, 25, 261-274.
(20) Yang, D.; Zhang, W.; Jiang, B.; Guo, Y. Silicone Rubber Ablative Composites Improved with Zirconium Carbide or Zirconia. Compos. Part A. 2013, 44, 70-77.
(21) Cerimele, C. J., Ried, R. C., Peterson, W. L., Zupp Jr, G. A., Stagnaro, M. J., & Ross, B. P. Assured Crew Return Vehicle. U.S. Pat. No. 3,118,636, Jan. 21, 1964.
(22) Guan Y, Zhang L X, Zhang L Q, Lu Y L. Study on Ablative Properties and Mechanisms of Hydrogenated Nitrile Butadiene Rubber (HNBR) Composites Containing Different Fillers. Polym. Degrad. Stab. 2011, 96, 808-817.
(23) Boonstra, B. B. Role of Particulate Filers in Elastomer Reinforcement: a Review. Polymer 1979, 20, 691-704.
(24) George, K. Thermal Insulation Behaviour of Ethylene Propylene Diene Monomer Rubber/Kevlar Fiber Based Hybrid Composites Containing Nanosilica for Solid Rocket Motor Insulation. J. Appl. Polym. Sci. 2020, 138, 49934.
(25) Winne, J. M.; Leibler, L.; Du Prez, F. E. Dynamic Covalent Chemistry in Polymer Networks: A Mechanistic Perspective. Polym. Chem. 2019, 10, 6091-6108.
(26) Montarnal, D.; Capelot, M.; Tournilhac, F.; Leibler, L. Silica-like Malleable Materials from Permanent Organic Networks. Science 2011, 334, 965-968.
(27) Guerre, M.; Taplan, C.; Winne, J. M.; Du Prez, F. E. Vitrimers: Directing Chemical Reactivity to Control Material Properties. Chem. Sci. 2020, 11, 4855-4870.
(28) Scheutz, G. M.; Lessard, J. J.; Sims, M. B.; Sumerlin, B. S. Adaptable Crosslinks in Polymeric Materials: Resolving the Intersection of Thermoplastics and Thermosets. J. Am. Chem. Soc. 2019, 141, 16181-16196.
(29) Chen, X.; Dam, M. A.; Ono, K.; Mal, A.; Shen, H.; Nutt, S. R.; Sheran, K.; Wudl, F. A Thermally Re-Mendable Cross-Linked Polymeric Material. Science 2002, 295, 1698-1702.
(30) Gheneim, R.; Perez-berumen, C.; Gandini, A. Diels—Alder Reactions with Novel Polymeric Dienes and Dienophiles: Synthesis of Reversibly Cross-Linked Elastomers. Macromolecules 2002, 35, 7246-7253.
(31) Taplan, C.; Guerre, M.; Prez, F. E. Du. Covalent Adaptable Networks Using β-Amino Esters as Thermally Reversible Building Blocks. J. Am. Chem. Soc. 2021, 143, 9140-9150.
(32) Elling, B. R.; Dichtel, W. R. Reprocessable Cross-Linked Polymer Networks: Are Associative Exchange Mechanisms Desirable?ACS Cent. Sci. 2020, 6, 1488-1496.
(33) Mondal, S.; Lessard, J. J.; Meena, C. L.; Sanjayan, G. J.; Sumerlin, B. S. Janus Cross-Links in Supramolecular Networks. J. Am. Chem. Soc. 2022, 144, 845-853.
(34) Zhang, L.; Rowan, S. J. Effect of Sterics and Degree of Cross-Linking on the Mechanical Properties of Dynamic Poly(Alkylurea-urethane) Networks. ACS Macro Lett. 2017, 50, 5051-5060.
(35) Van Zee, N. J.; Nicolay, R. Vitrimers: Permanently Crosslinked Polymers with Dynamic Network Topology. Prog. Polym. Sci. 2020, 104, 101233.
(36) Spiesschaert, Y.; Taplan, C.; Stricker, L.; Guerre, M.; Winne, J. M.; Du Prez, F. E. Influence of the Polymer Matrix on the Viscoelastic Behaviour of Vitrimers. Polym. Chem. 2020, 11, 5377-5385.
(37) Wu, S.; Chen, Q. Advances and New Opportunities in the Rheology of Physically and Chemically Reversible Polymers. Macromolecules 2022, 55, 697-714.
(38) Maassen, E. E. L.; Heuts, J. P. A.; Sijbesma, R. P. Reversible Crosslinking and Fast Stress Relaxation in Dynamic Polymer Networks via Transalkylation Using 1,4-Diazabicyclo[2.2.2] Octane. Polym. Chem. 2021, 12, 3640-3649.
(39) Capelot, M.; Unterlass, M. M.; Tournilhac, F.; Leibler, L. Catalytic Control of the Vitrimer Glass Transition. ACS Macro Lett. 2012, 1, 789-792.
(40) Wang, Y.; Pan, Y.; Zheng, Z.; Ding, X. Reconfigurable and Reprocessable Thermoset Shape Memory Polymer with Synergetic Triple Dynamic Covalent Bonds. Macromol. Rapid Commun. 2018, 39, 1-8.
(41) Self, J. L.; Dolinski, N. D.; Zayas, M. S.; Read De Alaniz, J.; Bates, C. M. Bronsted-Acid-Catalyzed Exchange in Polyester Dynamic Covalent Networks. ACS Macro Lett. 2018, 7, 817-821.
(42) Self, J. L.; Sample, C. S.; Levi, A. E.; Li, K.; Xie, R.; De Alaniz, J. R.; Bates, C. M. Dynamic Bottlebrush Polymer Networks: Self-Healing in Super-Soft Materials. J. Am. Chem. Soc. 2020, 142, 7567-7573.
(43) Nishimura, Y.; Chung, J.; Muradyan, H.; Guan, Z. Silyl Ether as a Robust and Thermally Stable Dynamic Covalent Motif for Malleable Polymer Design. J. Am. Chem. Soc. 2017, 139, 14881-14884.
(44) Van Lijsebetten, F.; Holloway, J. O.; Winne, J. M.; Du Prez, F. E. Internal Catalysis for Dynamic Covalent Chemistry Applications and Polymer Science. Chem. Soc. Rev 2020, 49, 8425-8438.
(45) Cromwell, O. R.; Chung, J.; Guan, Z. Malleable and Self-Healing Covalent Polymer Networks through Tunable Dynamic Boronic Ester Bonds. J. Am. Chem. Soc. 2015, 137, 6492-6495.
(46) Cash, J. J.; Kubo, T.; Bapat, A. P.; Sumerlin, B. S. Room-Temperature Self-Healing Polymers Based on Dynamic-Covalent Boronic Esters. Macromolecules 2015, 48, 2098-2106.
(47) Wang, S.; Ma, S.; Li, Q.; Yuan, W.; Wang, B.; Zhu, J. Robust, Fire-Safe, Monomer-Recovery, Highly Malleable Thermosets from Renewable Bioresources. Macromolecules 2018, 51, 8001-8012.
(48) Geng, H.; Wang, Y.; Yu, Q.; Gu, S.; Zhou, Y.; Xu, W.; Zhang, X.; Ye, D. Vanillin-Based Polyschiff Vitrimers: Reprocessability and Chemical Recyclability. ACS Sustain. Chem. Eng. 2018, 6, 15463-15470.
(49) Denissen, W.; Rivero, G.; Nicolay, R.; Leibler, L.; Winne, J. M.; Du Prez, F. E. Vinylogous Urethane Vitrimers. Adv. Funct. Mater 2015, 25, 2451-2457.
(50) Guerre, M.; Taplan, C.; Nicolay, R.; Winne, J. M.; Du Prez, F. E. Fluorinated Vitrimer Elastomers with a Dual Temperature Response. J. Am. Chem. Soc. 2018, 140, 13272-13284.
(51) Chen, F.; Gao, F.; Zhong, J.; Shen, L.; Lin, Y. Fusion of Biobased Vinylogous Urethane Vitrimers with Distinct Mechanical Properties. Mater Chem. Front. 2020, 4, 2723-2730.
(52) Zhu, Y.; Gao, F.; Zhong, J.; Shen, L.; Lin, Y. Renewable Castor Oil and DL-Limonene Derived Fully Bio-Based Vinylogous Urethane Vitrimers. Eur Polym. J. 2020, 135, 109865.
(53) Spiesschaert, Y.; Guerre, M.; Baere, I. De; Paepegem, W. Van; Winne, J. M.; Prez, F. E. Du. Dynamic Curing Agents for Amine-Hardened Epoxy Vitrimers with Short (Re)Processing Times. Macromolecules 2020, 53, 2485-2495.
(54) Wang, S.; Li, L.; Liu, Q.; Urban, M. W. Self-Healable Acrylic-Based Covalently Adaptable Networks. Macromolecules 2022, 55, 4703-4709.
(55) Lessard, J. J.; Garcia, L. F.; Easterling, C. P.; Sims, M. B.; Bentz, K. C.; Arencibia, S.; Savin, D. A.; Sumerlin, B. S. Catalyst-Free Vitrimers from Vinyl Polymers. Macromolecules 2019, 52, 2105-2111.
(56) Lessard, J. J.; Scheutz, G. M.; Hughes, R. W.; Sumerlin, B. S. Polystyrene-Based Vitrimers: Inexpensive and Recyclable Thermosets. ACS Appl. Polym. Mater 2020, 2, 3044-3048.
(57) Lessard, J. J.; Scheutz, G. M.; Sung, S. H.; Lantz, K. A.; Epps, T. H.; Sumerlin, B. S. Block Copolymer Vitrimers. J. Am. Chem. Soc. 2020, 142, 283-289.
(58) Lessard, J. J.; Stewart, K. A.; Sumerlin, B. S. Controlling Dynamics of Associative Networks through Primary Chain Length. Macromolecules 2022, 55, 10052-10061.
(59) Kissounko, D. A.; Taynton, P.; Kaffer, C. New Material: Vitrimers Promise to Impact Composites. Reinf Plast. 2018, 62, 162-166.
(60) Yang, Y.; Xu, Y.; Ji, Y.; Wei, Y. Functional Epoxy Vitrimers and Composites. Prog. Mater Sci. 2021, 120, 100710.
(61) Bai, L.; Zheng, J. Robust, Reprocessable and Shape-Memory Vinylogous Urethane Vitrimer Composites Enhanced by Sacrificial and Self-Catalysis Zn (II)—Ligand Bonds. Compos. Sci. Technol. 2020, 190, 108062.
(62) Kamble, M.; Vashisth, A.; Yang, H.; Pranompont, S.; Picu, C. R.; Wang, D.; Koratkar, N. Reversing Fatigue in Carbon-Fi Ber Reinforced Vitrimer Composites. Carbon 2022, 187, 108-114.
(63) Huang, B.; He, H.; Dufresne, A.; He, X.; Wang, S. Industrial Crops & Products Enhancing Toughness, Healing and Reprocessability of Sustainable Epoxy Vitrimer Composites by PEG-Assisted Regenerated Cellulose. Ind. Crop. Prod. 2021, 170, 113804.
(64) Ghosh, B.; Urban, W. M. Self-Repairing Oxetane-Substituted Chitosan Polyurethane Networks. Science 2009, 323, 1458-1460.
(65) Fang, H.; Ye, W.; Yang, K.; Song, K.; Wei, H.; Ding, Y. Vitrimer Chemistry Enables Epoxy Nanocomposites with Mechanical Robustness and Integrated Conductive Segregated Structure for High Performance Electromagnetic Interference Shielding. Compos. Part B 2021, 215, 108782.
(66) Swartz, J. L.; Li, R. L.; Dichtel, W. R. Incorporating Functionalized Cellulose to Increase the Toughness of Covalent Adaptable Networks. ACS Appl. Mater Interfaces 2020, 12, 44110-44116.
(67) Lossada, F.; Guo, J.; Jiao, D.; Groeer, S.; Bourgeat-Lami, E.; Montarnal, D.; Walther, A. Vitrimer Chemistry Meets Cellulose Nanofibrils: Bioinspired Nanopapers with High Water Resistance and Strong Adhesion. Biomacromolecules 2019, 20, 1045-1055.
(68) Liu, Y.; Wang, B.; Ma, S.; Yu, T.; Xu, X.; Li, Q.; Wang, S.; Han, Y.; Yu, Z.; Zhu, J. Catalyst-Free Malleable, Degradable, Bio-Based Epoxy Thermosets and Its Application in Recyclable Carbon Fiber Composites. Compos. Part B Eng. 2021, 211, 108654.
(69) Wang, S.; Ma, S.; Li, Q.; Xu, X.; Wang, B.; Yuan, W.; Zhou, S.; You, S.; Zhu, J. Facile: In Situ Preparation of High-Performance Epoxy Vitrimer from Renewable Resources and Its Application in Nondestructive Recyclable Carbon Fiber Composite. Green Chem. 2019, 21, 1484-1497.
(70) Guo, Z.; Wang, W.; Liu, Z.; Xue, Y.; Zheng, H.; Majeed, K.; Zhang, B.; Zhou, F.; Zhang, Q. Preparation of Carbon Nanotube-Vitrimer Composites Based on Double Dynamic Covalent Bonds: Electrical Conductivity, Reprocessability, Degradability and Photo-Welding. Polymer 2021, 235, 124280.
(71) Luo, S.; Wei, X.; Jin, Y.; Qiu, L.; Zhang, W. Malleable and Recyclable Vitrimer—Graphene Aerogel Composite with High Electrical Conductivity. ACS Appl. Electron. Mater 2021, 3, 1178-1183.
(72) Legrand, A.; Soulié-Ziakovic, C. Silica—Epoxy Vitrimer Nanocomposites. Macrmolecules 2016, 49, 5893-5902.
(73) Chen, X.; Li, L.; Wei, T.; Venerus, D. C.; Torkelson, J. M. Reprocessable Polyhydroxyurethane Network Composites: Effect of Filler Surface Functionality on Cross-Link Density Recovery and Stress Relaxation. ACS Appl. Mater Interfaces 2019, 11, 2398-2407.
(74) McMullin, E.; Rebar, H. T.; Mather, P. T. Biodegradable Thermoplastic Elastomers Incorporating POSS: Synthesis, Microstructure, and Mechanical Properties. Macromolecules 2016, 49, 3769-3779.
(75) Kuo, S.; Hong, J.; Huang, Y.; Chen, J.; Fan, S.; Ko, F.; Chu, C.; Chang, F. Star Poly (N-Isopropylacrylamide) Tethered to Polyhedral Oligomeric Silsesquioxane (POSS) Nanoparticles by a Combination of ATRP and Click Chemistry. J. Nanomater 2012, 2012, 7.
(76) Stewart, K. A.; Shuster, D.; Leising, M.; Coolidge, I.; Lee, E.; Stevens, C.; Peloquin, A. J.; Kure, D.; Jennings, A. R.; Iacono, S. T. Synthesis, Characterization, and Thermal Properties of Fluoropyridyl-Functionalized Siloxanes of Diverse Polymeric Architectures. Macromolecules 2021, 54, 4871-4879.
(77) Liu, H.; Zheng, S. Polyurethane Networks Nanoreinforced by Polyhedral Oligomeric Silsesquioxane. Macromol. Rapid Commun. 2005, 26, 196-200.
(78) Morgan, A. B., & Kilinc, M. Silicon-Based Flame Retardants. Non-halogenated Flame Retardant Handbook 2021, 271.
(79) Mettry, M.; Worthington, M. A.; Au, B.; Forien, J. B.; Chandrasekaran, S.; Heth, N. A.; Schwartz, J. J.; Liang, S.; Smith, W.; Biener, J.; Saha, S. K.; Oakdale, J. S. Refractive Index Matched Polymeric and Preceramic Resins for Height-Scalable Two-Photon Lithography. RSC Adv. 2021, 11, 22633-22639.
(80) Yang, H.; He, C.; Russell, T. P.; Wang, D. Epoxy-Polyhedral Oligomeric Silsesquioxanes (POSS) Nanocomposite Vitrimers with High Strength, Toughness, and Efficient Relaxation. Giant 2020, 4, 100035.
(81) Hajiali, F.; Tajbakhsh, S.; Marid, M. Thermally Reprocessable Bio-Based Polymethacrylate Vitrimers and Nanocomposites. Polymer 2021, 212, 123126.
(82) Zhao, B.; Hang, G.; Li, L.; Zheng, S. Nanocomposites of Polyethylene with Polyhedral Oligomeric Silsesquioxane: From Thermoplastics to Vitrimers through Silyl Ether Metathesis. Mater Today Chem. 2022, 24, 100759.
(83) Hu, S.; Chen, X.; Bin, M. A.; Purwanto, N. S.; Torkelson, M. Reprocessable Polyhydroxyurethane Networks Reinforced with Reactive Polyhedral Oligomeric Silsesquioxanes (POSS) and Exhibiting Excellent Elevated Temperature Creep Resistance. Polymer 2022, 252, 124971.
(84) Cai, Y.; Zou, H.; Zhou, S.; Chen, Y.; Liang, M. Room-Temperature Self-Healing Ablative Composites via Dynamic Covalent Bonds for High-Performance Applications. ACS Appl. Polym. Mater 2020, 2, 3977-3987.
(85) Fina, A.; Tabuani, D.; Cariato, F.; Frache, A.; Boccaleri, E.; Camino, G. Polyhedral Oligomeric Silsesquioxanes (POSS) Thermal Degradation. Thermochim. Acta 2006, 440, 36-42.
(86) Schnurre, S. M.; Gr, J. Thermodynamics and Phase Stability in the Si—O System. J. Non. Cryst. Solids 2004, 336, 1-25.
(87) Haida, P.; Abetz, V. Acid-Mediated Autocatalysis in Vinylogous Urethane Vitrimers. Macromol. Rapid Commun. 2020, 41, 2000273.

### Supportive Information for Example 1

Instrumentation: Nuclear Magnetic Resonance (NMR) Spectroscopy. ¹H NMR spectra were recorded on a Bruker 600 MHz NMR spectrometer or a Magritek 60 mHz Spinsolve Ultra spectrometer. Deuterated chloroform (CDCl₃) was used as solvent, and the residual solvent signal served as a reference.

Fourier Transform Infrared (FTIR) Spectroscopy. Infrared spectra were acquired on a PerkinElmer Spectrum One FTIR spectrometer equipped with a PIKE MIRacle single reflection ATR accessory containing a diamond crystal sample plate. Spectra were processed using PerkinElmer Spectrum 10 software.

Thermogravimetric Analysis (TGA) and Simultaneous Thermal Analysis (STA). Low-temperature TGA experiments were collected on a TA 5500, equipped with an autosampler using a 100 L platinum pan. Each sample was run immediately after destruction/compression molding to limit possible moisture uptake. Ramp experiments were heated at 10° C./min from room temperature to 650° C. under nitrogen flow (25 mL/min). All low-temperature TGA experiments were recorded using TA's Thermal Advantage for Q Series software. High-temperature STA experiments were conducted on a Netzsch STA 449 F5 Jupiter, equipped with an autosampler using a premium alumina crucible with lid. Ramp experiments were heated at 10° C./min from room temperature to 1150° C. under nitrogen flow (20 mL/min).

High-Temperature Atmospheric Sintering. High-temperature sintering studies were performed using a Thermoscientific Thermolyne F6000 muffle furnace and each sample was heated in air to the designated temperature at 10° C./min and held for 12 hours before natural cooling back to room temperature (furnace shut off but left closed). Samples were heated on an alumina plate. Each sample underwent exposure at 300° C., 650° C., and 1100° C., followed by notional cooling rates of 2 hours (from 300° C.), 4 hours (from 650° C.), and 6 hours (from 1100° C.).

Differential Scanning Calorimetry (DSC). DSC experiments were conducted on a TA Q2500 DSC (TA Instruments, New Castle, DE), equipped with an autosampler, and refrigerated cooling system 90, using aluminum hermetic sealed pans. Ramp experiments were heated under nitrogen (25 mL/min) at 10° C./min from −50 to 185° C. and cooled from 185 to −50° C., with 5-min isotherms at each extreme. All DSC experiments were recorded using the Thermal Advantage for Q Series software from TA.

X-ray Diffraction (XRD). XRD experiments were conducted on a Rigaku Miniflex (Rigaku Corporation, The Woodlands, TX) with a copper ka x-ray tube. Measurements of solid polymer disks were taken using Miniflex Guidance software at room temperature and pressure across a 20 range of 10° to 90° with a step size of 0.02° and a speed of 10°/min. The voltage and current were 40 kV and 15 mA, respectively. No smoothing, fitting, or treatment of the spectra was performed.

Dynamic Mechanical Analysis (DMA). DMA experiments were collected on the TA Q800 DMA (TA Instruments, New Castle, DE). DMA experiments provided quantitative information on the viscoelastic and rheological properties of the materials by measuring the response of the vitrimers while being subjected to a 0.05% sinusoidal strain. Using a tensile clamp, each rectangular-shaped sample was heated from −30 to 180° C. at a rate of 3° C./min. Sample dimensions were kept consistent as length ×width ×thickness measured approximately (20 mm×6 mm×1 mm). All experiments were run at a frequency of 1 Hz, and the glass transition temperature (T_{g}) was taken as the peak of tan 6. All DMA experiments were recorded using the Thermal Advantage for Q Series software from TA.

Shear Rheology. Shear rheology for creep recovery was performed using a TA Instruments Discovery Hybrid Rheometer (DHR-2) operating at 150° C. with a 20 mm flat-plate geometry. Creep recovery experiments were performed at 5000 Pa for 400 s, followed by 0 Pa for 200 s. Curves depicted are an average of two vitrimer discs of the same formulation.

Shear rheology for stress relaxation was performed using an Anton-Paar MCR-702 rheometer operating at 175 to 155° C. with a 20 mm flat-plate geometry (part 45950). Stress relaxation experiments were conducted at 0.3% strain at the desired temperature. All experiments were conducted using the Anton software. All samples were allowed to equilibrate at temperature prior to each run.

### Experimental

Materials. OctaSilane POSS (H-POSS, Hybrid Plastics, 98%), allyl alcohol (Acros Organics, 99+%), platinum(0)-1,3-divinyl-1,1,3,3-tetramethyldisiloxane complex solution in xylene (Karstedt's catalysts, Millipore Sigma, 2% Pt), 4-vinylbenzyl chloride (VBC, Millipore Sigma, 90%), sodium acetate (ACS grade, Millipore Sigma), tert-butyl acetoacetate (TBAA, Millipore Sigma, 98%), anhydrous toluene (ACS grade, Fisher), dimethyl sulfoxide (DMSO, ACS grade, Fisher), tetrahydrofuran (THF, ACS grade, Fisher), 200 proof ethanol (ACS grade, Fisher), xylylene diamine (XDA, Millipore Sigma, 99%), hexamethylenediamine (HMDA, Millipore Sigma, 98%), and 1,12-diaminododecane (DADD, Millipore Sigma, 98%) were used as received.

Synthesis of OP-POSS. OctaSilane POSS (H-POSS, 5.09 g, 1.00 equiv) was added to a 25 mL RBF containing 17 mL of anhydrous toluene. A stir bar was added, and the RBF was charged with 3.06 mL of allyl alcohol. The reaction vessel was placed in an ice bath and allowed to stir for 10 min. Slowly, 45.0 L of Karstedt's catalyst was added dropwise to the reaction vessel and, upon complete addition, the solution was allowed to stir for 15 min. The reaction vessel was removed from the ice bath, equipped with a reflux condenser, and stirred in a 90° C. oil bath for 22 h. The biphasic solution was removed from heat, allowed to cool to room temperature, and diluted with 20 mL of acetone. A dark gray precipitate was gravity filtered and the filtrate was rotary evaporated to dryness to give a clear, viscous yellow oil (7.23 g, 97.5%). ¹H NMR (CDCl₃, 600 MHz): δ 3.62-3.55 (t, 16H), 1.70-1.60 (p, 16H), 0.65-0.58 (t, 16H), 0.22-0.18 (s, 48H); ¹³C NMR (CDCl₃, 600 MHz): δ 65, 26, 13, −0.9 (See FIGS. 3.1A and B).

Synthesis of 4-Vinylbenzyl alcohol (VBA). 4-Vinylbenzyl chloride (10.3 mL, 1.00 equiv.) was added to a 50 mL RBF containing 40 mL of DMSO. A stir bar was added, and 6.58 g of sodium acetate was added. The reaction vessel was capped and placed in a 40° C. oil bath for 24 hours. The reaction was then cooled to room temperature and poured into 60 mL of D1 water. The aqueous solution was extracted with ethyl acetate (3×20 mL), combined, dried with sodium sulfate, and rotary evaporated to a clear, colorless liquid. The product was then reconstituted in 30 mL of ethanol, to which 25 mL of 20% NaOH was added. The reaction vessel was equipped with a condenser and placed in a 70° C. oil bath for 4 hours. The solution was allowed to cool to room temperature and extracted with ethyl acetate (3×50 mL), washed with D1 water (2×100 mL) and brine (3×75 mL). The organic layers were combined, dried with sodium sulfate, and rotary evaporated to give a brownish red oil. The product was purified via column chromatography (2:1 hexanes/ethyl acetate) as a mobile phase to give a clear, slightly colored oil (4.920 g, 50.4%). ¹H NMR (CDCl₃, 600 MHz): δ 7.50-7.10 (m, 4H), 6.85-6.45 (m, 1H), 5.80-5.50 (d, 1H), 5.25-5.10 (d, 1H), 4.50 (s, 2H), 3.10-3.00 (s, 1H) (See FIG. 3.4).

Synthesis of OBA-POSS. 4-Vinylbenzyl alcohol (4.92 g, 36.6 mmol, 9.00 equiv.) was added to a 50 mL RBF containing 17 mL of anhydrous toluene. H-POSS (4.12 g, 4.05 mmol, 1.00 equiv.) was added and the solution was stirred on in an ice bath for 10 minutes. Slowly, 45.0 L of Karstedt's catalyst was added dropwise to the reaction vessel and, upon complete addition, the solution was allowed to stir for 15 minutes. The reaction vessel was removed from the ice bath, equipped with a reflux condenser, and stirred in a 90° C. oil bath for 20 hours. The biphasic solution was removed from heat, allowed to cool to room temperature, and diluted with 20 mL of acetone. A dark gray precipitate was gravity filtered and the filtrate was rotary evaporated at elevated temperatures for 2 h to give a dark, extremely viscous brown oil with a slight excess of VBA. The product was used without further purification (8.23 g, 97.2%). ¹H NMR (CDCl₃, 600 MHz): δ 3.62-3.55 (t, 16H), 1.70-1.60 (p, 16H), 0.65-0.58 (t, 16H), 0.22-0.18 (s, 48H) (See FIG. 3.5).

Synthesis of POSS1. Tert-butyl acetoacetate (TBAA, 7.12 mL, 8.80 equiv.) was added to a 50 mL RBF containing OP-POSS (7.23 g, 1.00 equiv.) and a stir bar. The RBF was equipped with a distillation apparatus and stirred at room temperature for 10 minutes. After, the RBF was submerged in a 120° C. oil bath and stirred for 18 hours. The reaction mixture was then placed under reduced pressure to vacuum distill off the excess TBAA at 125° C. for 2 hours, yielding a clear, very viscous yellow oil (10.2 g, 96.8%). ¹H NMR (CDCl₃, 600 MHz): δ 4.18-4.10 (t, 14H), 3.45-3.40 (s, 14H), 2.28-2.25 (s, 21H), 1.70-1.60 (p, 16H), 0.65-0.58 (t, 16H), 0.22-0.18 (s, 48H) (See Scheme 1A and FIGS. 3.2-3.3).

Synthesis of POSS2. Tert-butyl acetoacetate (TBAA, 5.78 mL, 8.80 equiv.) was added to a 50 mL RBF containing OBA-POSS (8.23 g, 1.00 equiv.) and a stir bar. The RBF was equipped with a distillation apparatus and stirred at room temperature for 10 minutes. After, the RBF was submerged in a 120° C. oil bath and stirred for 12 hours. The reaction mixture was then placed under reduced pressure to vacuum distill off the excess TBAA at 125° C. for 4 hours, yielding a very viscous yellow oil with slight excess dark, extremely viscous brown oil with slight excess TBAA present. The product was used without further purification (10.2 g, 93.2%). ¹H NMR (CDCl₃, 600 MHz): δ 4.18-4.10 (t, 14H), 3.45-3.40 (s, 14H), 2.28-2.25 (s, 21H), 1.70-1.60 (p, 16H), 0.65-0.58 (t, 16H), 0.22-0.18 (s, 48H) (See Scheme 1B and FIGS. 3.6-3.7).

Preparation of X1. POSS1 (87.5% functionalized, 1.00 g, 0.483 mmol, 1.00 equiv.) was loaded into a Petri dish and dissolved in THF (8 mL). In a separate vial, XDA (0.245 mL, 1.86 mmol, 3.85 equiv.) was diluted with 2 mL of THF. The XDA solution was added to the Petri dish, and the solvent was evaporated at room temperature. The resulting film was further cured at 85° C. for 6 h under vacuum yielding a vitrimer film. The resulting film was ground, and compression molded at 160° C. under reduced pressure, yielding a yellow, transparent material (See FIG. 2.2.

Preparation of H1. POSS1 (87.5% functionalized, 1.00 g, 0.483 mmol, 1.00 equiv.) was loaded into a Petri dish and dissolved in THF (8 mL). In a separate vial, HMDA (0.243 mL, 1.86 mmol, 3.85 equiv.) was diluted with 2 mL of THF. The HMDA solution was added to the Petri dish, and the solvent was evaporated at room temperature. The resulting film was further cured at 85° C. for 6 h under vacuum yielding a vitrimer film. The resulting film was ground, and compression molded at 160° C. under reduced pressure, yielding a yellow, transparent material.

Preparation of D1. POSS1 (87.5% functionalized, 1.00 g, 0.483 mmol, 1.00 equiv.) was loaded into a Petri dish and dissolved in THF (6 mL). In a separate vial, DADD (0.373 g, 1.86 mmol, 3.85 equiv.) was diluted with 2 mL of THF and heated with a heat gun until DADD was mostly solubilized. The DADD solution was rapidly added to the Petri dish. An additional 2 mL of THF was added to the DADD vial, heated, and added to the Petri dish. Then, the solvent was evaporated at room temperature. The resulting film was further cured at 85° C. for 6 h under vacuum yielding a vitrimer film. The resulting film was ground, and compression molded at 160° C. under reduced pressure, yielding a yellow, transparent material.

Preparation of X2. POSS2 (87.5% functionalized, 1.00 g, 0.362 mmol, 1.00 equiv.) was loaded into a Petri dish and dissolved in THF (8 mL). In a separate vial, XDA (0.184 mL, 1.39 mmol, 3.85 equiv.) was diluted with 2 mL of THF. The XDA solution was added to the Petri dish, and the solvent was evaporated at room temperature. The resulting film was further cured at 85° C. for 6 h under vacuum yielding a vitrimer film. The resulting film was ground, and compression molded at 160° C. under reduced pressure, yielding a brownish yellow, transparent material. (See FIG. 2.3).

Preparation of H2. POSS2 (87.5% functionalized, 1.00 g, 0.362 mmol, 1.00 equiv.) was loaded into a Petri dish and dissolved in THF (8 mL). In a separate vial, HMDA (0.182 mL, 1.39 mmol, 3.85 equiv.) was diluted with 2 mL of THF. The HMDA solution was added to the Petri dish, and the solvent was evaporated at room temperature. The resulting film was further cured at 85° C. for 6 h under vacuum yielding a vitrimer film. The resulting film was ground, and compression molded at 160° C. under reduced pressure, yielding a brownish yellow, transparent material.

Preparation of D2. POSS2 (87.5% functionalized, 1.00 g, 0.483 mmol, 1.00 equiv.) was loaded into a Petri dish and dissolved in THF (6 mL). In a separate vial, DADD (0.373 g, 1.86 mmol, 3.85 equiv.) was diluted with 2 mL of THF and heated with a heat gun until DADD was mostly solubilized. The DADD solution was rapidly added to the Petri dish. An additional 2 mL of THF was added to the DADD vial, heated, and added to the Petri dish. Then, the solvent was evaporated at room temperature. The resulting film was further cured at 85° C. for 6 h under vacuum yielding a vitrimer film. The resulting film was ground, and compression molded at 160° C. under reduced pressure, yielding a yellow, transparent material.

Characterization. NMR spectroscopy was used to characterize monomers and their monomer precursors. FTIR spectroscopy, and x-ray diffraction (XRD) were used to characterize the polymers. Thermogravimetric analysis (TGA), differential scanning calorimetry (DSC), atmospheric thermal degradation, and chemical degradation were conducted to evaluate thermochemical properties. Dynamic mechanical analysis (DMA), creep-recovery, and stress-relaxation were conducted to observe mechanical and viscous behavior. Swelling experiments evaluated solvent resistance and mesh size/swelling ratios.

The Archimedes method was utilized for density measurements. The experimental details are summarized in the Supporting Information.

### REFERENCES

(1) Edholm, O.; Blomberg, C., Stretched exponentials and barrier distributions. Chem. Phys. 2000, 252, 221-225.
(2) Goodwin, J. W.; Hughes, R. W., Rheology for Chemists: An Introduction. Royal Society of Chemistry: 2008; p 95-100
(3) Montarnal, D.; Capelot, M.; Tournilhac, F.; Leibler, L., Silica-Like Malleable Materials from Permanent Organic Networks. Science 2011, 334, 965-968
(4) Ishibashi, J. S. A.; Kalow, J. A., Vitrimeric Silicone Elastomers Enabled by Dynamic Meldrum's Acid-Derived Cross-Links. ACS Macro Lett. 2018, 7, 482-486.
(5) Ogden, W. A.; Guan, Z., Recyclable, Strong, and Highly Malleable Thermosets Based on Boroxine Networks. J. Am. Chem. Soc. 2018, 140, 6217-6220.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wto, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A composition comprising: a hybrid inorganic-organic vitrimer having a weigh percent of a polyhedral silsesquioxane (POSS)-derivative of about 10 to 60 weight percent.

2. The composition of claim 1, wherein the hybrid inorganic-organic vitrimer comprises the following structure: 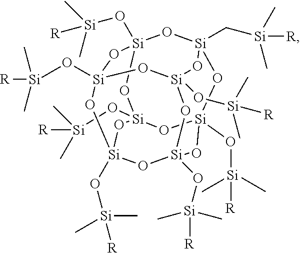
wherein each R is independently selected from:

| | Unbranched | Branched/Heteroatom/Polyol | Benzylic/Unsaturated | Phenolic/Unsaturated |
|---|---|---|---|---|
| R = | 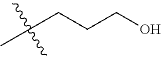 [SMILES: *CCCO] | 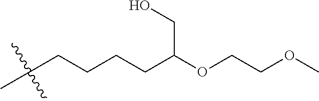 [SMILES: *CCCCC(CO)OCCOC] | 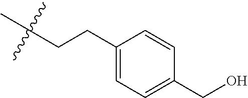 [SMILES: *CCc1ccc(CO)cc1] | 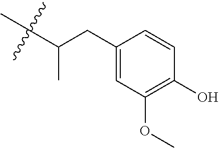 [SMILES: *C(C)Cc1ccc(O)c(OC)c1] |
| | 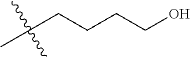 [SMILES: *CCCCO] | 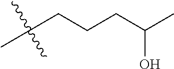 [SMILES: *CCCC(C)O] | 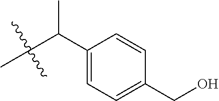 [SMILES: *C(C)c1ccc(CO)cc1] | 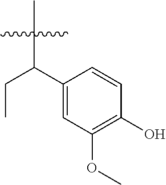 [SMILES: *C(CC)c1ccc(O)c(OC)c1] |
| | 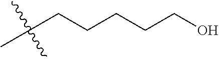 [SMILES: *CCCCCO] | 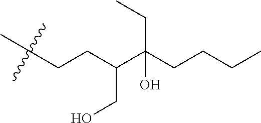 [SMILES: *CCC(CO)C(O)(CC)CCCC] | 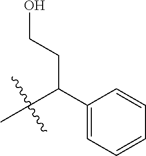 [SMILES: *C(CCO)c1ccccc1] | 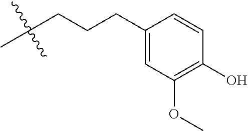 [SMILES: *CCCc1ccc(O)c(OC)c1] |
| | | 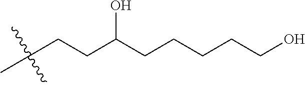 [SMILES: *CCC(O)CCCCCO] | 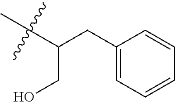 [SMILES: *C(CO)Cc1ccccc1] | 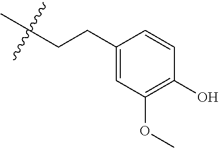 [SMILES: *CCc1ccc(O)c(OC)c1] |
| | | | | 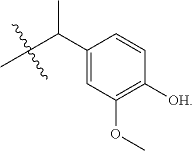 [SMILES: *C(C)c1ccc(O)c(OC)c1] |

3. The composition of claim 2, wherein two or more of the R groups are the same.

4. The composition of claim 2, wherein the R group is unbranched.

5. The composition of claim 2, wherein the R group is branched/heteroatom/polyol.

6. The composition of claim 2, wherein the R group is benzylic/unsaturated.

7. The composition of claim 2, wherein the R group is phenolic/unsaturated.

8. The composition of claim 4, wherein all of the R groups are the same.

9. The composition of claim 1, wherein the hybrid inorganic-organic vitrimer comprises the following structure: 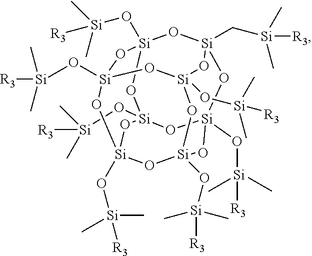
wherein each R₃ group is independently an ester functional group with the proceeding carbon is a hydrocarbon chain having 1 to 10, wherein the hydrocarbon chain is saturated or unsaturated, branch or unbranched, a heteroatom-hydrocarbon chain, an acyl group, an aryl group, or a —C(H₂)—C(O)—R₄, where the R₄ group is an alkyl group.

10. The composition of claim 1, wherein the hybrid inorganic-organic vitrimer comprises the following structure: 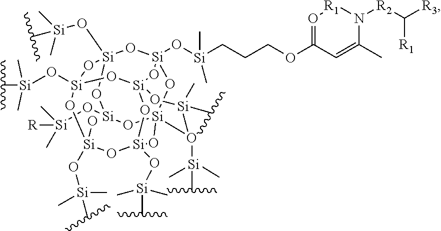
wherein each Si group includes two methyl groups and the following group: 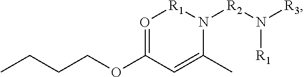
where each R1 group independently is H or an alkyl group, wherein each R2 independently can be an alkyl group or spacer such as the following: 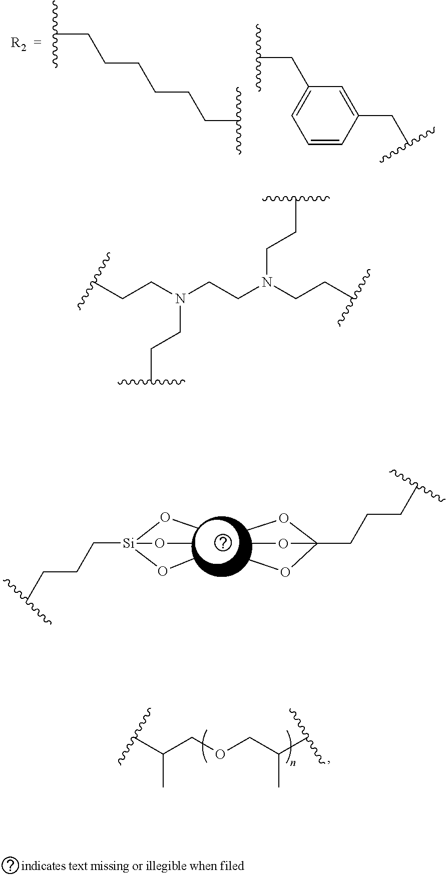
where the spacer group is bonded to one or more other hybrid inorganic-organic vitrimers; and
wherein each R₃ group is an ester functional group with the proceeding carbon is a hydrocarbon chain having 1 to 10, wherein the hydrocarbon chain is saturated or unsaturated, branch or unbranched, a heteroatom-hydrocarbon chain, an acyl group, an aryl group, or a —C(H₂)—C(O)—R₄, where the R₄ group is an alkyl group.

11. The composition of claim 1, wherein the hybrid inorganic-organic vitrimer having a weigh percent of a polyhedral silsesquioxane (POSS)-derivative of about 30 to 55 weight percent.

12. The composition of claim 1, wherein the hybrid inorganic-organic vitrimer having a weigh percent of a polyhedral silsesquioxane (POSS)-derivative of about 40-60 weight percent.

13. A method of making a hybrid inorganic-organic vitrimer having a weigh percent of a polyhedral silsesquioxane (POSS)-derivative of about 10 to 60 weight percent, comprising:

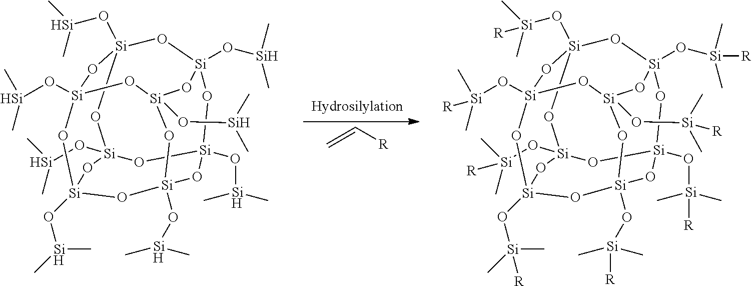

| | Unbranched | Branched/Heteroatom/Polyol | Benzylic/Unsaturated | Phenolic/Unsaturated |
|---|---|---|---|---|
| R = | 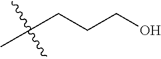 [SMILES: *CCCO] | 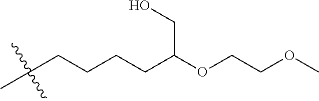 [SMILES: *CCCCC(CO)OCCOC] | 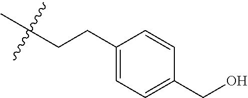 [SMILES: *CCc1ccc(CO)cc1] | 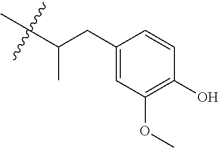 [SMILES: *C(C)Cc1ccc(O)c(OC)c1] |
| | 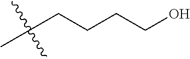 [SMILES: *CCCCO] | 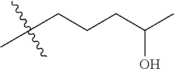 [SMILES: *CCCC(C)O] | 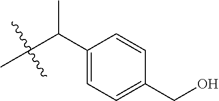 [SMILES: *C(C)c1ccc(CO)cc1] | 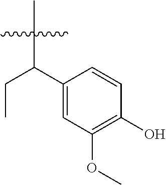 [SMILES: *C(CC)c1ccc(O)c(OC)c1] |
| | 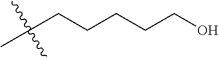 [SMILES: *CCCCCO] | 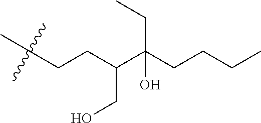 [SMILES: *CCC(CO)C(O)(CC)CCCC] | 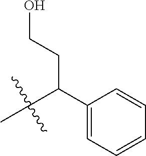 [SMILES: *C(CCO)c1ccccc1] | 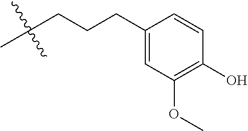 [SMILES: *CCCc1ccc(O)c(OC)c1] |
| | | 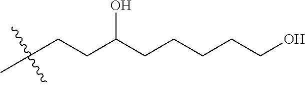 [SMILES: *CCC(O)CCCCCO] | 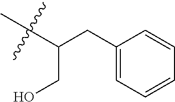 [SMILES: *C(CO)Cc1ccccc1] | 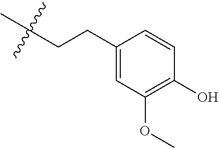 [SMILES: *CCc1ccc(O)c(OC)c1] |
| | | | | 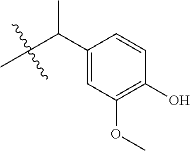 [SMILES: *C(C)c1ccc(O)c(OC)c1] |

14. The method of claim 13, wherein two or more of the R groups are the same.

15. The method of claim 13, wherein the R group is unbranched.

16. The method of claim 13, wherein the R group is branched/heteroatom/polyol.

17. The method of claim 13, wherein the R group is benzylic/unsaturated.

18. The method of claim 13, wherein the R group is phenolic/unsaturated.

19. The method of claim 15, wherein all of the R groups are the same.

20. A method of making a hybrid inorganic-organic vitrimer having a weigh percent of a polyhedral silsesquioxane (POSS)-derivative of about 10 to 60 weight percent, comprising:

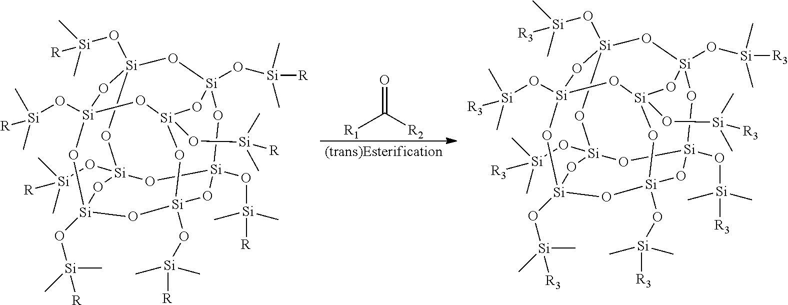

| | Acid/Acid Halide | | Activated Esters | | Traditional Esters | |
|---|---|---|---|---|---|---|
| R₁ = | 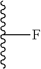 [SMILES: *F] | 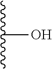 [SMILES: *O] | 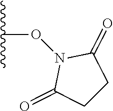 [SMILES: *ON1C(=O)CCC1=O] | 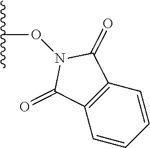 [SMILES: *ON1C(=O)c2ccccc2C1=O] | 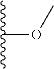 [SMILES: *OC] | 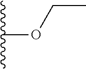 [SMILES: *OCC] |
| | 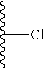 [SMILES: *Cl] | | 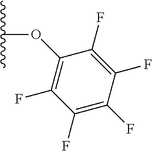 [SMILES: *Oc1c(F)c(F)c(F)c(F)c1F] | 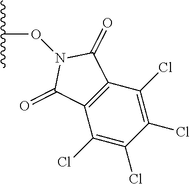 [SMILES: *ON1C(=O)c2c(Cl)c(Cl)c(Cl)c(Cl)c2C1=O] | 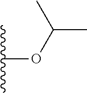 [SMILES: *OC(C)C] | 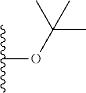 [SMILES: *OC(C)(C)C] |
| | 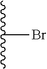 [SMILES: *Br] | | | | | |
| | | |
|---|---|---|
| R₂ = | Alkyl (branched, unbrached, unsaturated) | Acyl (where R₄ is a carbon atom; see below) |
| | Aryl (substituted or unsubstituted) (or) | 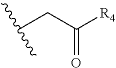 |
| | |
|---|---|
| R₃ = | Ester functional group where the proceeding carbon is a hydrocarbon chain that is saturated, |
| | unsaturated, branched, unbrached, heteroatom contaning, or an acyl group. Acyl group |
| | functionality is specified within the R₂ subject line above. |

21-26. (canceled)
